(19) United States
(12) Patent Application Publication
(10) Pub. No.: US 2016/0195287 A1
(43) Pub. Date: Jul. 7, 2016

(54) Holding Cabinets With Closed-Loop Environmental Control Systems, Methods For Controlling Environmental Conditions In Holding Cabinets, And Computer-Readable Media Storing Instructions For Implementing Such Methods

(71) Applicant: HENNY PENNY CORPORATION, Eaton, OH (US)

(72) Inventors: Manouchehr Shirali, Richmond, IN (US); Jingjing Shen, West Chester, OH (US)

(73) Assignee: Henny Penny Corporation, Eaton, OH (US)

(21) Appl. No.: 14/916,067

(22) PCT Filed: Sep. 3, 2014
(86) PCT No.: PCT/US14/53795

§ 371 Date: Mar. 2, 2016

Related U.S. Application Data
(60) Provisional application No. 61/946,931, filed on Mar. 3, 2014.
(60) Provisional application No. 61/873,029, filed on Sep. 3, 2013.

(51) Int. Cl. F24F 11/00; G05B 15/02

(52) U.S. Cl. CPC F24F 11/006; G05B 15/02

(57) ABSTRACT

Methods disclosed herein may be methods for maintaining environmental conditions in a cabinet. Such methods may comprise determining a relative humidity set point. Such methods may comprise activating a fan configured to circulate air within said cabinet. Such methods may comprise supplying humidity by activating a heater in a fluid pan or a mist generator. Such methods may comprise measuring a relative humidity, an air temperature, and a rate of airflow in said cabinet. Such methods may comprise adjusting a duty cycle of said heater and said fan in response to said air temperature, said relative humidity, and said rate of airflow to maintain said relative humidity within a predetermined range based on the relative humidity set point. Computer-readable instructions to perform such methods may be stored on non-transitory, computer-readable media. Further, a system comprising a processor and a memory storing such computer-readable instructions may implement such methods.

### CROSS-REFERENCE TO RELATED APPLICATIONS

This application claims priority to U.S. Provisional Patent Application No. 61/873,029 filed on Sep. 3, 2013, and U.S. Provisional Patent Application No. 61/946,931 filed on Mar. 3, 2014, the disclosures of which are incorporated herein by reference in their entirety.

### BACKGROUND OF THE INVENTION

1. Field of the Invention

The present invention relates to a holding cabinet, which provides a more consistent and accurate holding environment for food products. In particular, the invention relates to a holding cabinet, which provides a more consistent and accurate holding environment for food products by providing closed-loop control of environmental conditions within the cabinet as a controlled process variable.

2. Description of Related Art

With the increasing popularity of “fast food” establishments where food is precooked for later sale, there is a demand for food holding devices that maintain food at a substantially uniform temperature for selected periods of time while preserving the taste, moisture content, texture and quality of the food. Further, in other applications, it is desirable to be able to restore food, particularly baked goods, to acceptable quality after long storage periods.

In many instances, storage of “fast foods” is particularly difficult because heat loss, bacteria growth and moisture loss experience by the food at storage conditions provided by prior art devices, particularly where the food is to be stored warm, contribute to rapid deterioration of the food.

More particularly, it has been found that air circulation characteristics and improper storage temperature contribute significantly to bacteria growth and excessive loss of moisture which leads to food shrinkage, so that in improper storage atmosphere the food deteriorates after only a short period of time and loses its tenderness, appetizing taste, and appearance.

It has also been found that even where food is stored under favorable conditions in an enclosure, the food deteriorates at a rate dependent on the time the door to the enclosure is opened so the storage chamber is exposed to the ambient atmosphere.

Additionally, it is known that in storage of some foods, such as fried chicken or fish, where a crust is provided, it is particularly desirable to maintain the crispness of the crust while minimizing the moisture loss from the underlying meat. Storage of such foods tends to involve the satisfaction of seemingly mutually exclusive conditions, to hold the crispness of the crust by maintaining low moisture content in the crust while minimizing moisture loss from the food. In such foods, excessive moisture-loss results in shrinkage and loss of tenderness and adversely affects the texture of the meat. This may be prevented by controlling the temperature and humidity of the storage atmosphere. The problem is to prevent moisture flow from the underlying food to the crust while holding the crust in low moisture content.

There are presently numerous cabinets for holding food products or other items in a temperature and humidity-controlled state. These cabinets, however, suffer from a common shortcoming. When the cabinets are opened to insert additional food products or other items or to remove such products or items from the cabinets, heat and humidity are lost. Unless the lost heat and humidity is restored, the items stored in the cabinets may cool or dry out, or both.

Proofing and holding are distinct food preparation processes. Proofing is a process generally applied to yeast bread products, in which the yeast grows and the bread rises due to yeast growth by products. Holding, however, is a process during which food characteristics and quality are maintained, e.g., the temperature, moisture content, texture, and color of the food remain unchanged. Thus, in proofing, food product characteristics change, while in holding, those characteristics remain the same.

In terms of process parameters, proofing may be distinguished from holding mainly by lower process temperatures. Humidity may be greater than about 80% RH, but the selected humidity may vary widely depending on the particular bread product to be proofed. Nevertheless, proofing temperatures are generally lower than holding temperatures. High proofing temperatures might inhibit yeast growth. However, high holding temperatures are desirable because such temperatures may suppress the growth of bacteria, molds, and the like and may increase the holding time for food products.

Previously, various methods and devices have been developed to attempt to maintain heat and humidity. For example, pans of water have been placed in the cabinets and allowed to evaporate naturally in an attempt to maintain humidity. Despite its simplicity, this method has not been completely successful. Natural evaporation does not quickly compensate for humidity losses. Further, while humidity naturally increases, items stored in the cabinets are subject to the drying effect of heat. Moreover, because natural evaporation is effected by the temperature within the cabinet, the rate of humidity adjustment may fluctuate with temperature changes, but humidity adjustments will probably lag behind such temperature changes.

Systems have been developed by which the heat and humidity levels of air within a cabinet are more closely controlled. Air may be heated by passing it over, across, or through various types of heating elements. Air may also be passed over, across, or through water in order to raise the humidity of the air. Despite these improvements, known systems remain unable to precisely adjust for losses of heat or humidity due to disruptions to the cabinet environment, such as opening and closing the cabinet access, and adding or removing food products or other items.

Further, the addition of heating elements and humidity generating means create additional problems. If heat or humidity rises too quickly, the air within the cabinets could become overheated or too moist. Such uncontrolled fluctuations in heat and humidity may be detrimental to food product or other items stored within the cabinets.

Cabinets commonly are equipped with thermostats in an attempt to control the heat of the air circulating within the cabinets. By controlling the air temperature, however, the humidity of the air also may be affected. Nevertheless, such controls alone do not provide adequate control of the humidity within the cabinet. Moreover, a thermostat or manual potentiometer may not maintain temperature and humidity within predetermined parameters. Generally, such devices only cause the heating elements to heat the air when the air temperature falls below a set value.

Some cabinets known in the art, such as those described in U.S. Pat. No. 6,832,732, further include a humidity sensor. Such cabinets periodically monitor the humidity of air inside a cabinet chamber and adjust the humidity of the inside are by selectively opening and closing vents in the cabinet chamber and selectively heating water stored at the base of the cabinet chamber. Accordingly, such cabinets create a feedback loop, which constantly monitors and changes the humidity of air inside the cabinet chamber. Nevertheless, such cabinets are still only able to maintain the quality of food products stored therein for a short time (e.g., 20 minutes) before the quality of such food products begins to degrade.

### SUMMARY OF THE INVENTION

A need has arisen for holding cabinets for attaining closed-loop environmental control by means of one or more environmental sensors and one or more controllers configured to adjust environmental conditions within such holding cabinets based on readings from the one or more environmental sensors. Consequently, in particular configurations of cabinets disclosed herein, such cabinets may comprise one or more of a temperature sensor, a humidity sensor, and airflow sensor, and the control systems of such cabinets may utilize the readings from such sensors to adjust one or more of the temperature within a cabinet chamber, the humidity within the cabinet chamber, and the flow of air within the cabinet chamber (e.g., environmental conditions within the cabinet), such that the environmental conditions within the cabinet extend the holding time for food products stored within the cabinet chamber before significant degradation in quality of the food products occurs (e.g., noticeable changes in taste, texture, or tenderness, significant bacterial growth). Accordingly, such cabinets may implement a feedback loop to ensure that the environmental conditions within the cabinet are maintained within a predetermined range. Such a predetermined range may be a particular combination of environmental conditions (e.g., temperature, humidity, and airflow) that extends the holding time for food products, before significant degradation in quality occurs, compared to other combinations of the environmental conditions. In addition, in many configurations of cabinets disclosed herein, regulation of the environmental conditions may be independent of product load size (e.g., the amount of food product held in the cabinet). Particular configurations of cabinets disclosed herein may utilize various fans, blowers, vacuums, heaters, mist generators, vents, and other devices to regulate environmental conditions.

Moreover, different food products may possess different material properties. Therefore, a further need has arisen to maintain the environmental conditions within the cabinet in a predetermined range, specific to a particular food product, such that the holding time of the particular food product, before the quality of the particular food product degrades significantly, is extended. Consequently, in certain configurations of cabinets disclosed herein, the control systems of such cabinets may store different predetermined ranges of environmental conditions for different types of food products.

Still a further need has arisen for cabinets that may be used for both proofing and holding. In some configurations of cabinets disclosed herein, the control systems of such cabinets may default to a generally higher temperature associated with a holding mode of operation. It is an advantage of this default setting that such cabinets may inhibit the growth of bacteria in food products.

Methods disclosed herein may be methods for maintaining environmental conditions in a cabinet. Such methods may comprise determining a relative humidity set point. Such methods may comprise activating a fan configured to circulate air within said cabinet. Such methods may comprise activating a humidity-supplying device, such as a heater in a fluid pan or a mist generator. Such methods may comprise measuring a relative humidity, an air temperature, and a rate of airflow in said cabinet. Such methods may comprise adjusting a duty cycle of said heater and said fan in response to said air temperature, said relative humidity, and said rate of airflow to maintain said relative humidity within a predetermined range based on the relative humidity set point. Computer-readable instructions to perform such methods may be stored on non-transitory, computer-readable media. Further, a system comprising a processor and a memory storing such computer-readable instructions may implement such methods.

Other objects, features, and advantages of the present invention will be apparent to persons of ordinary skill in the art in view of the following detailed description of embodiments of the invention and the accompanying drawings.

### BRIEF DESCRIPTION OF THE DRAWINGS

For a more complete understanding of the embodiments of the present invention, needs satisfied thereby, and the objects, features, and advantages thereof, reference now is made to the following description taken in connection with the accompanying drawings.

FIG. 1 depicts a front view of the holding cabinet according to an embodiment of the present invention.

FIG. 2 depicts a side view of the holding cabinet according to an embodiment of the present invention.

FIG. 3 depicts a cross-sectional view of the holding cabinet of the present invention, along line III-III of FIG. 1.

FIG. 4 depicts a cross-sectional view of the holding cabinet of the present invention, along line IV-IV of FIG. 2.

FIG. 5 is a schematic depiction of the air and humid air circulation within the holding cabinet according to an embodiment of the present invention.

FIG. 6 is a perspective view of a water pan cover and ring assembly according to an embodiment of the present invention.

FIG. 7 is a schematic depiction of the humidity generating pan and the control and monitoring interconnections of the holding cabinet according to an embodiment of the present invention.

FIG. 8 depicts the circuitry of the humidity detection transducer according to an embodiment of the present invention.

FIGS. 9A and 9B are side and top views of a slide vent according to an embodiment of the present invention.

FIGS. 10A and 10B are schematic depictions of the slide vent and cabinet openings according to an embodiment of the present invention.

FIG. 11 is a flowchart of the process for vent operation according to an embodiment of the present invention.

FIG. 12 is a flowchart of the calibration process for the slide vent motor according to an embodiment of the present invention.

FIG. 13 is a depiction of the period of the slide vent according to an embodiment of the present invention.

FIG. 14A depicts a humidity regulation state diagram according to an embodiment of the present invention; and FIG. 14B is a graphical representation of the humidity control process according to an embodiment of the present invention.

FIG. 15 is a flowchart of the process for increasing humidity according to an embodiment of the present invention.

FIG. 16 is a flowchart depicting the operation of the closed-loop humidity control system.

FIG. 17 is a flowchart of an environmental control process for controlling the environmental conditions in the holding cabinet.

FIG. 18 is a schematic of a controller that may control operations of the holding cabinet.

FIG. 19A is an exploded schematic of a mist generator according to an embodiment of the present invention; and FIG. 19B is an exploded schematic of a mist generator according to another embodiment of the present invention.

FIG. 20 is a flowchart of an environmental control process for controlling the environmental conditions in the holding cabinet utilizing the mist generators of FIGS. 19A and 19B.

### DETAILED DESCRIPTION OF EMBODIMENTS OF THE INVENTION

Exemplary embodiments disclosed herein may, for example, reduce waste and improve profits for customers by extending the life of fried food. In particular configurations, methods and systems disclosed herein may optimize the holding variables, including holding temperature and relative humidity with controllable equipment. In developing the invention, the inventors have investigated the effects of parameters, such as relative humidity (“RH”), airflow rate (“AR”), and temperature (“T”), on the sensory quality of fried food after an extended hold time. Further, the inventors measured the field variables (e.g., RH, AF, and T) inside of the holding cabinet to provide reference for design. Based on a series of dynamic tests, the inventors determined that there is a need for a controlled environment inside the cabinet, and the inventors developed the methods disclosed herein to improve the product quality of products stored in a holding cabinet for an extended time. Nevertheless, the invention disclosed herein also contemplates monitoring and adjusting other variables that may have an effect on the sensory quality of food stored in a holding cabinet.

In addition to the advantages described above, the invention disclosed herein may provide certain other advantages. For example, regulation of environmental conditions within the cabinet may be independent of product load size. Further, the invention disclosed herein may allow for a plurality of set points (e.g., different temperatures, humidity values, and airflow rates), which may each correspond to a particular product type or category to be held in the cabinet (e.g., the inventors have determined that the life of different products may be extended, but such extensions may require different settings for each different product). In addition, the invention disclosed herein may extend product quality for a longer time while said product is being held in the cabinet.

Still further, in certain configurations, the invention disclosed herein may optimize the combination of the variables for better product quality. Such results may be accomplished, for example, by measuring the airflow rate and determining how it affects sensory attributes. Further, selectively controlling a heat source in the cabinet also may slow down food quality degradation. In addition, systems disclosed herein may quantify sensory attributes in a manner that may permit fine tuning and adjustment of environmental conditions, which may further extend the life of held food products.

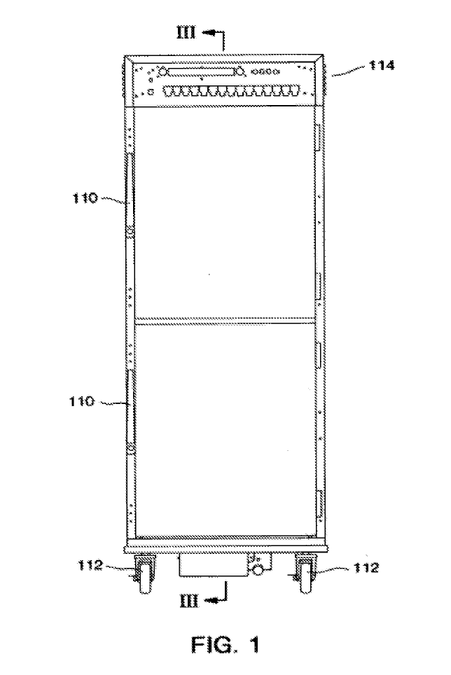

Embodiments of the present invention, and their features and advantages, may be understood by referring to FIGS. 1-20, like numerals being used for corresponding parts in the various drawings. While process steps disclosed herein are described in an exemplary order, the invention is not so limited, and the process steps described herein may be performed in any order. Further, one or more of the process steps may be omitted in certain configurations.

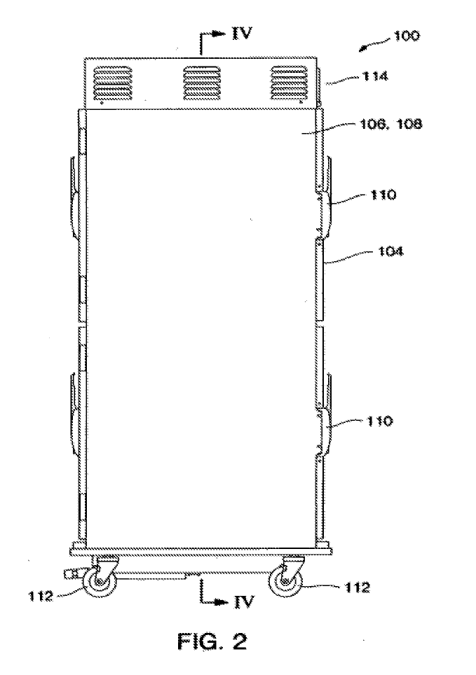

Referring to FIGS. 1 and 2, a front view of the holding cabinet and a side view of the holding cabinet according to an embodiment of the present invention are provided. Holding cabinet 100 has a front 102, back 104, and sides 106 and 108. Front 102 and back 104 may both have at least one door with a corresponding locking mechanism 110. In the embodiment depicted in FIGS. 1 and 2, front 102 and back 104 each have two doors.

Module 114 is provided to house equipment used to control the relative humidity in cabinet 100. In an embodiment, holding cabinet 100 may be provided with a plurality of wheels 112.

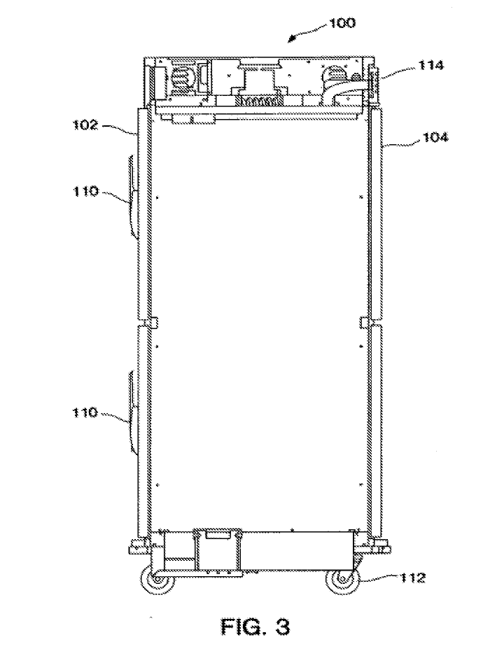

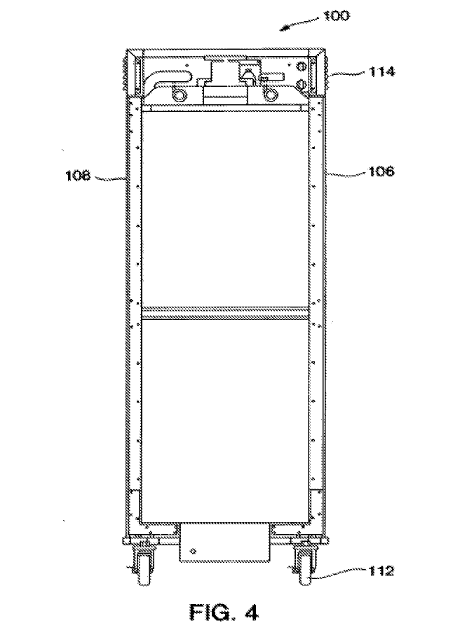

Referring to FIG. 3, a cross-sectional view of the holding cabinet of the present invention, along line III-III of FIG. 1 is provided. Referring to FIG. 4, a cross-sectional view of the holding cabinet of the present invention, along line IV-IV of FIG. 2 is provided.

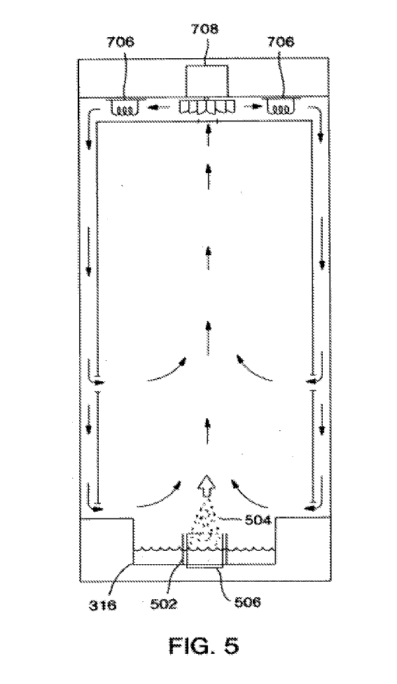

Referring to FIG. 5, a schematic depiction of the air and humid air circulation within the holding cabinet according to one embodiment of the present invention is provided. Blower motor 708 is provided, as are heaters 706. In the embodiment shown, two heaters 706 are provided; other numbers and locations of heater 706 may also be used.

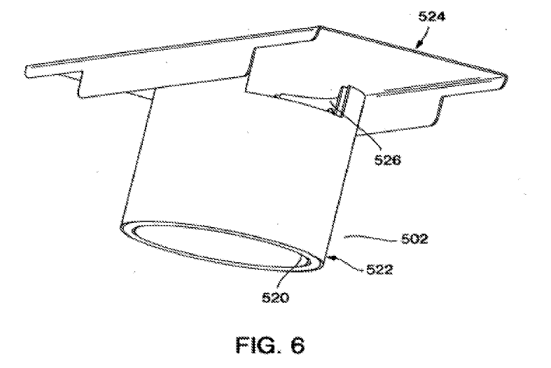

Water pan 316 is provided with water pan cover and ring assembly 502, which is shown in detail in FIG. 6. Water pan cover and ring assembly 502 includes inner ring 520, outer ring 522, and cover 524. Steam exhaust ports 526 may be provided. In one embodiment, two exhaust ports 526 are provided, at opposite sides of the rings.

Referring again to FIG. 5, water in water pan 316 is heated by a water pan heater 506, which causes the water in water pan 316 to vaporize into steam 504. Inner and outer rings 520 and 522 of assembly 502 concentrate heat generated by water pan heater 506, assisting in the vaporization.

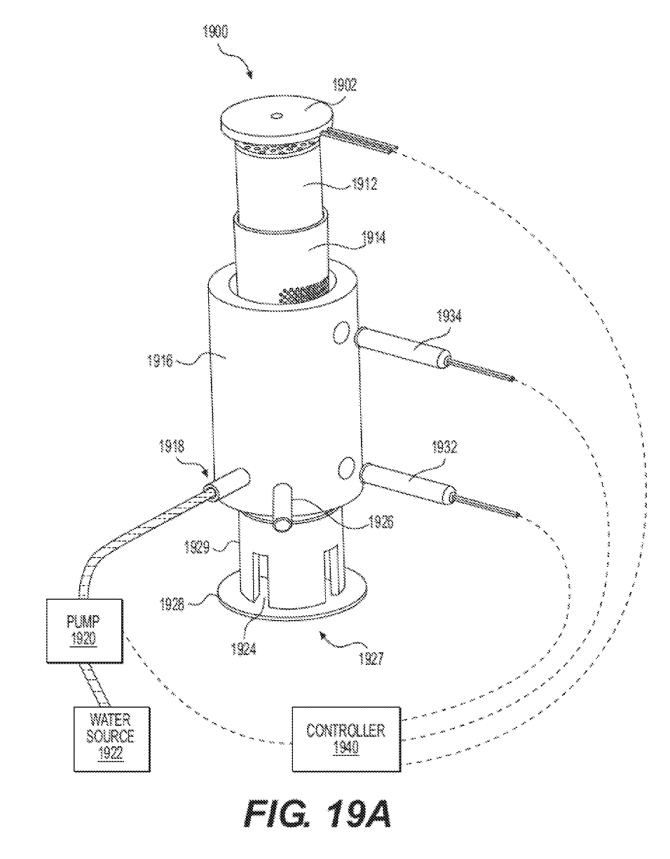

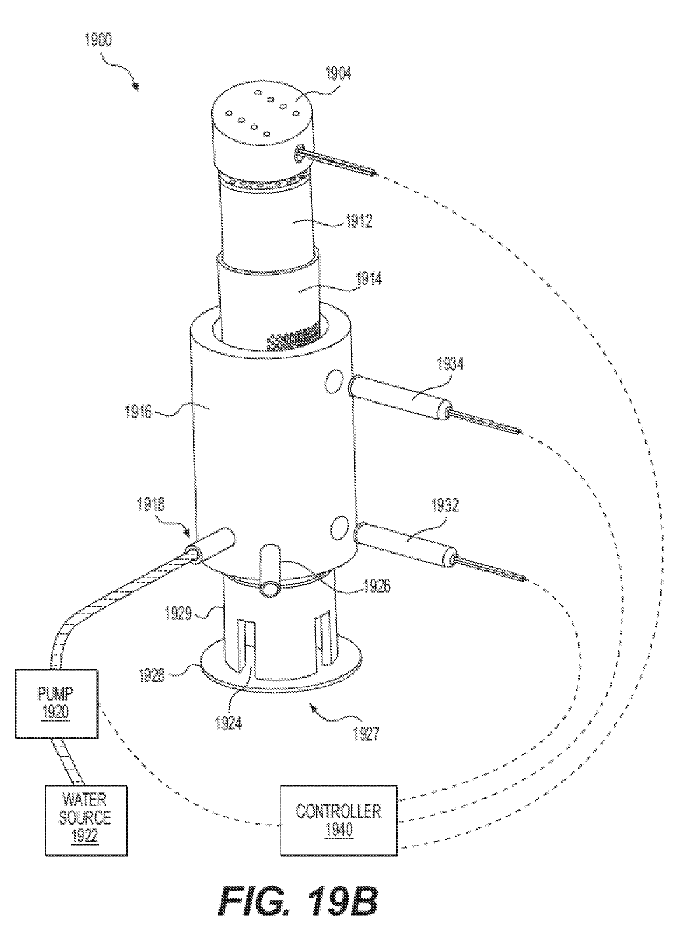

One or more mist generators 1900 may be used in place of or in addition to water pan 316, water pan heater 506, and assembly 502. Such mist generators 1900 are disclosed in more detail below, with respect to FIGS. 19A and 19B.

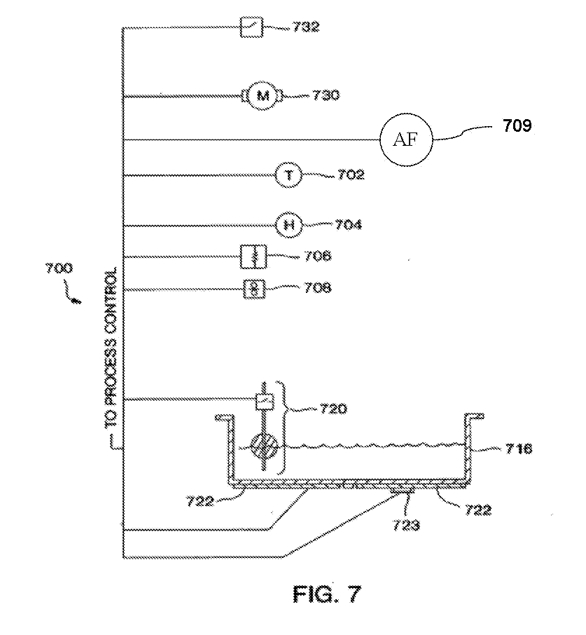

FIG. 7 depicts a block diagram of system 700 according to an embodiment of the present invention. System 700 includes air temperature probe 702, which measures the temperature of the air in the holding cabinet. Air temperature probe 702 may also be used to provide temperature compensation for humidity sensor 704. In one embodiment, air temperature probe 702 may be part number DC32006A-3-18, manufactured by Durex Industries, Cary, Ill.

Humidity sensor 704 measures the relative humidity of the air in the cabinet (H1). In an embodiment, humidity sensor 704 may be E&E Electronik Part No. EE00-FR3, manufactured by JLC International, Warminster, Pa. Air heater 706 heats the air in the cabinet to the set point specified by the user. In one embodiment, air heater 606 may be part number U3-32-764-34, 500 W, 1000 W, or 1500 W, manufactured by Watlow, Hannibal, Mo. Air fan 708 circulates heated air through the cabinet so that the entire cabinet volume is at the same temperature. In one embodiment, air fan 708 may be part number SX-19695 (240V) or SX-20441 (208V), manufactured by Jakel, Highland, Ill.

System 700 also may include at least one airflow sensor 709, which may measure the rate of airflow in the cabinet. Such an airflow sensor 709 may be disposed anywhere in the holding cabinet, such as, for example, near or at one or more of water pan 716, an entry point where air is blown into the cabinet chamber, opening 906, air temperature probe 702, humidity sensor 704, and a central location in the cabinet chamber.

Further, a plurality of airflow sensors 709 may be disposed through the cabinet, so that an average rate of airflow may be determined.

Water pan 716 holds water to be boiled to create humidity. In one embodiment, water pan heater 722 may be #-8-MSM22866-xxx, manufactured by Minco, Minneapolis, Minn. In another embodiment, heating elements may be screened onto water pan 716. Float switch 720 is provided to determine the water level in water pan 716. In an embodiment, float switch 720 may control water flow into water pan 716 when the water level is below a desired level. A water pan heater (RTD) temperature sensor 723 is affixed to water pan heater 722. Alternatively, sensor 723 may be integral with heater 722. Sensor 723 may measure the temperature of heater 722 and input such measured temperature values to System 700.

Water pan heater temperature sensor 723 is linked to control system 700 to ensure that water pan heater 722 remains off when either of at least two conditions occurs: first, when no water is in water pan 716 or second, when float switch 720 fails. In normal operation, float switch 720 signals control system 700 that water pan 716 is empty, so control system 700 does not activate water pan heater 722. Nevertheless, line build-up, debris, or abuse may cause float switch 720 to fail in the “full water pan” position. Water pan 716 and water pan heater 722 may be quickly damaged when water pan heater 722 is activated while water pan 716 is empty. Water pan heater temperature sensor 723 performs as a backup to float switch 720 to reduce or eliminate the risk of such damage to water pan 716 or water pan heater 722, or both.

Slide vent motor 730 controls the movement of the slide vent, which, in turn opens and closes the cabinet vent. Slide vent position switch 732 is provided to provide an indication of the status of the vent. In one embodiment, side vent position switch 732 may be part number KWABQACC, manufactured by Cherry Electrical Products, Pleasant Prairie, Wis. Switch 732 may also be an optical proximity switch.

Process inputs and outputs connect to the process control as shown. Temperature sensor 723 may be built into heater 722 and may measure the water pan temperature.

One or more mist generators 1900 may be used in place of or in addition to water pan 716, water pan heater 722, water pan heater temperature sensor 723, and float switch 720. As noted above, such mist generators 1900 are disclosed in more detail below, with respect to FIGS. 19A and 19B.

The cabinet air temperature is regulated with air temp sensor 702, air heater 706 and air fan 708. The air temp regulation is obvious to those skilled in the art, and consists simply of regulating the air temperature to the programmed set point. This may be a simple thermostatic (on/off) control with hysteresis, or may be a more sophisticated PID (proportional/integral/derivative) control algorithm.

Humidity may be regulated by 1) adding humidity when the cabinet humidity is below the humidity set point; and 2) decreasing humidity by introducing outside ambient air to the cabinet, when the cabinet humidity is above the programmed set point. Thus, there may be at least two separate systems to regulate the humidity: a humidity generation system, such as, for example, mist generator 1900 or water pan 716 and water pan heater 722; and a “venting” system.

Airflow may be regulated by 1) adjusting the speed of air fan 708, and 2) opening and closing vents in the “venting system,” such that outside ambient air may enter the cabinet and interior air may escape the cabinet.

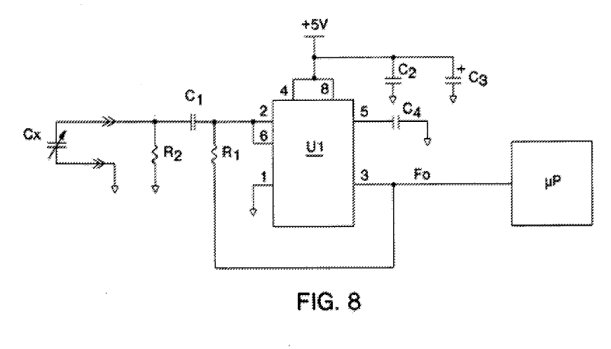

Referring to FIG. 8, humidity transducer circuit 800 according to one embodiment of the present invention is provided. Timer U1 forms an astable oscillator with output frequency, F_{O}, set by capacitors Cₓ, C₁, and resistor R₁. Capacitors C₂ and C₃ bypass power supply. Capacitor C₁ blocks DC voltage to transducer C, which is damaged by DC voltage. Resistor R₁ sets the frequency, F_{O}. Resistor R₂ drains charge from capacitor C₁ during power-down. Transducer Cₓ capacitance varies with humidity. Microprocessor μP measures F_{O} period by counting pulses (n₂) for 1/16 second.

Example values for the elements in FIG. 8 are provided below:

| Element | Value |
|---|---|
| U1 | LMC 555 C Timer |
| R₁ | 24.9K |
| R₂ | 5M |
| C₁ | .039 μF, 50 V, 1%, 100 PAM |
| C₂ | 0.1 μF ceramic disk |
| C₃ | 10 μF Tantalum |
| C_{X} | Humidity Transducer, E& E |
| | Electronik EE00-F123 |

The relative humidity percentage (% RH) may be determined by the following equation:

$$\% RH = 419.734 ( \frac{4343.287}{{n}_{2} + 360} - 1 )$$

Capacitance Cₓ also is affected by temperature, therefore, % RH is compensated for temperature with this equation:

% RH_{C}=[(T_{F}−140)(0.0016667)+1](% RH)

In the above-identified equation, T_{F} may correspond to air temperature in ° F., and % RH_{C} may be a parameter used to display and regulate humidity.

The systems of the present invention may implement a proofing mode of operation. As noted above, this invention may combine the proofing and holding functions in a single cabinet. For example, on initiation of any power-up condition, a user interface, e.g., a display, for the control system may offer the user the opportunity to initiate a “Proof” option. The user may have a limited time window, e.g., ten (10) seconds, within which to accept this option. The user may accept the option by activating a particular switch, e.g., a TEMP switch, or a combination of switches. When the option is not accepted during the time window, the control system initiates the hold (higher temperature) mode. However, when the option is accepted, the control system initiates the proof (lower temperature) mode.

The hold and proof modes are distinguished by the maximum allowable air temperature set point. For example, in the proof mode, the maximum allowable air temperature set point may be the minimum hold temperature. Thus, when the minimum hold temperature were 150° F., the maximum proof temperature set point would be 150° F. Similarly, when the minimum hold temperature were 150° F., the maximum allowable hold mode air temperature set point might be 220° F., and the hold mode temperature range might be 150° F. to 220° F.

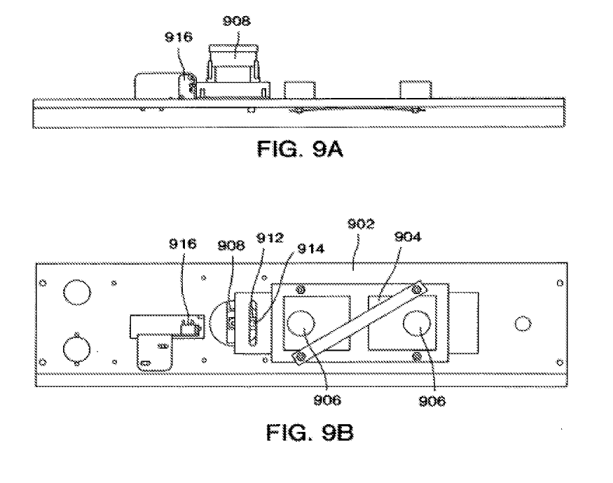

Referring to FIGS. 9A and 9B, side and top views of a slide vent according to an embodiment of the present invention are provided. In general, cabinet panel 902 is provided with slide panel 904. Both cabinet panel 902 and slide panel 904 have at least one opening 906. In one embodiment, openings 906 in cabinet panel 902 are fixed, while openings 902 in slide panel 904 slide relative to openings 906 in cabinet panel 902. Gear motor 908 drives slide panel 904 linearly to open or close openings 906 via lever arm 912 and slide pin 914. In one embodiment, motor 908 is model number EB-5206, manufactured by Custom Products, Inc., New Haven, Conn., or part number AB, manufactured by Hurst Manufacturing Corporation, Princeton, Ind.

As slide panel 904 slides relative to cabinet panel 902, openings 906 on slide panel 904 line up with openings 906 on cabinet panel 902, in effect opening a passage to the blower inlet and outlet (not shown). When slide panel 904 slides its full distance, openings 906 in cabinet panel 902 are fully uncovered. At this point, slide panel 904 begins sliding in the opposite direction, and openings 906 in cabinet panel 902 are covered, blocking access to the blower inlet and outlet (not shown).

Switch 916 is provided to indicate when vents 906 are fully closed. In another embodiment, switch 916 may be provided to indicate when vents 906 are fully opened. This variance may depend on the position of switch 916 with respect to slide 904. Other arrangements may be provided as desired. Switch 916 may be used during calibration to determine the period of slide vent 904. This is discussed in greater detail, below.

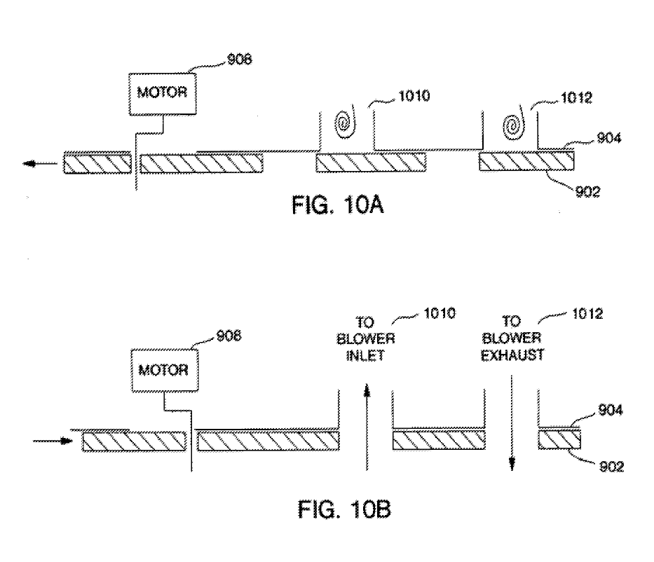

Referring to FIGS. 10A and 10B, depictions of the slide vent in its closed and open positions are provided, respectively. In FIG. 10A, slide vent 904 is positioned such that air does not flow from the exterior of the cabinet into blower inlet 1010, and out of blower exhaust 1012. When motor 908 is activated, however, slide vent 904 is moved, shown in FIG. 10B, opens blower inlet 1010 and blower exhaust 1012.

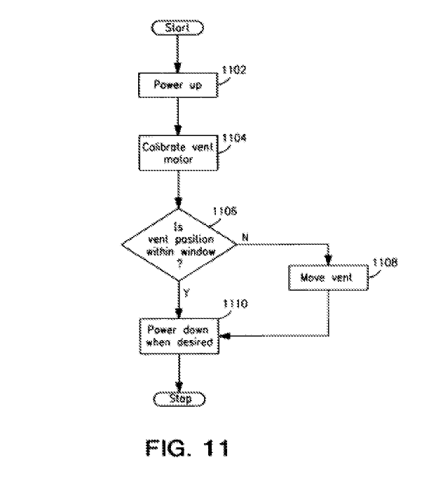

Referring to FIG. 11, a flowchart of the general operation of the cabinet is provided. In step 1102, the cabinet is powered up. This may involve a routine process of initializing cabinet components.

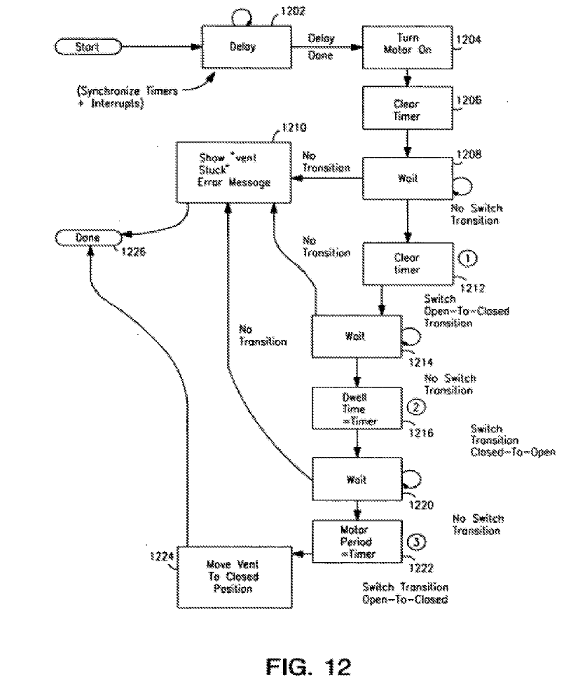

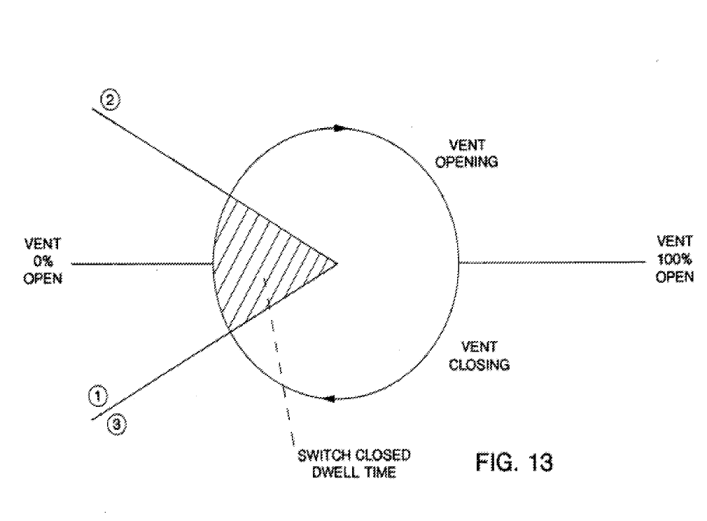

In step 1104, the vent motor is calibrated. This process is described in greater detail in FIGS. 12 and 13, below.

Referring to FIG. 12, a flowchart of the slide vent motor calibration process according to one embodiment of the present invention is provided. The purpose of the calibration is to account for variations in the actual time required to move the vent from one position to another. Even though a synchronous AC motor may be used, the time for one revolution may vary because 1) the line frequency may be 50 Hz or 60 Hz, and 2) friction and debris in the mechanism may slow the vent movement.

In general, the control software needs to know the time for one complete revolution to be able to move the vent from the fully-opened to the fully-closed position. The control knows when the vent is fully-closed, because a vent switch actuates at that position. Thus, when the actual period for the vent movement is T_{VENT}, then the vent is fully open at time T_{VENT}/2. Also, the control may move the vent to other positions, such as 50% open area, by actuating the motor for some time that is a fraction of T_{VENT}. For example, to open the vent to about 50% open area, the control activates the motor for about T_{VENT}/4, from either the fully-open or fully-closed position.

In one embodiment, although the vent open area is not a linear function of the vent motor actuation time, it provides a suitable approximation, permitting the vent motor actuation time to be used to position the slide vent. In another embodiment, different shapes for the vent holes may be used to provide a linear relationship between motor actuation time and vent open area.

FIG. 13 depicts the vent operation as far as the control is concerned. As the motor turns and the vent actuates the vent switch, the vent switch is really actuated for some period of time, which may be referred to as the “dwell time,” or T_{DWELL}. The control may account for T_{DWELL} when calculating the time needed to actuate the motor to achieve a given vent position.

Referring again to FIG. 12, in one embodiment, the vent calibration routine uses a timer that is always running, so there is no need to start or stop the timer, just a need to reset it to find the dwell time and the period. In step 1202, there is a predetermined delay, during which timers and interrupts are synchronized. In one embodiment, this may be a one second delay; other delays may be used, as required. In another embodiment, this delay may be omitted.

In step 1204, after the timers and interrupts are synchronized, the vent motor is activated, causing the slide vent to move. The timer is cleared in step 1206, and, in step 1208, the control waits for a first transition signal from vent switch. This signal indicates that the vent switch is being activated. When there is no switch signal within a predetermined time, an error message is presented to the user in step 1210. This may be by a visual or audible signal, such as a CRT, a LED, a bell, a chime, and the like. In an embodiment, a suitable message, such as “Vent Stuck” is displayed for the user.

In one embodiment, the predetermined amount of time may be 48 seconds. Other suitable lengths of time may be used as desired. This time may be selected based on, inter alia, the known general period of the vent. The time may also be selected to prevent damage to the motor. After the predetermined time is elapsed, the motor may be shut off.

If a signal is received from the vent switch, in step 1208, the timer is cleared, and in step 1214, the control waits for a second transition signal from the vent switch, indicating that the vent switch is no longer actuated. Similar to above, when a predetermined time passes without a signal from the vent switch, the user may be notified in step 1210. Once the second transition signal is received, in step 1216, the timer is read, indicating the dwell time, or T_{DWELL}. In step 1220, similar to steps 1208 and 1214, the control waits for a transition signal from the vent switch. Once a transition signal is received, indicating that the vent has completed its cycle, in step 1222, the timer is read. This is T_{VENT}.

In step 1224, the vent is moved to the fully-closed position. As discussed above, this may be achieved by activating the motor for T_{VENT}/2.

The control may use the time required to move the vent to detect faults in the vent system. When it takes longer than a predetermined time for one complete revolution, the control assumes that the vent is stuck, or the motor has failed, and displays a fault message.

Referring again to FIG. 11, in step 1106, the control determines when the vent position is within a predetermined tolerance of its requested position. In an embodiment, the vent position may be expressed as an opening percentage—from 100% open, to 0% open. In this step, it is determined when the actual position is within a predetermined window of the desired position. This may be about 10%, 5%, 2%, and the like. In one embodiment, it is about 1%. When the vent is within this window, no adjustments are made.

If, in step 1108, it is determined that the vent is not within the predetermined window, the vent motor is activated for a determined amount of time to move the vent to its desired position.

In step 1110, the device may be powered down. When this occurs, it is possible that humidity may condense on the humidity sensor as the air temperature within the cabinet drops. This may 1) damage the humidity sensor, or 2) cause false humidity readings during operation. In order to compensate for this problem, in one embodiment, the device enters “purge” mode that is activated when the control switch is changed from “operate” to “standby” or “off.” In this mode, the air heater and the water heater are turned off, and the fan is activated when the humidity is greater than a predetermined level. The predetermined humidity level may be selected as a compromise between low humidity (much lower than 100%) and high ambient humidity that exists within restaurants or other operating environments. In one embodiment, this percentage may be 80%.

When the fan is activated, air from outside the cabinet is injected into the cabinet, for the most part, preventing the humidity in the cabinet from exceeding the predetermined level. In general, controlling the humidity in the cabinet involves regulating the water heat output and the vent motor output. The water heat output is usually turned on to increase humidity within the cabinet, while the vent is usually opened to reduce humidity within the cabinet.

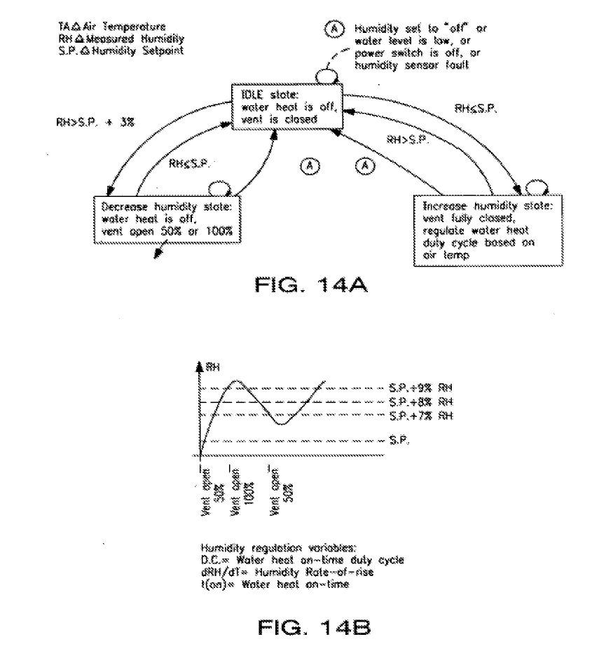

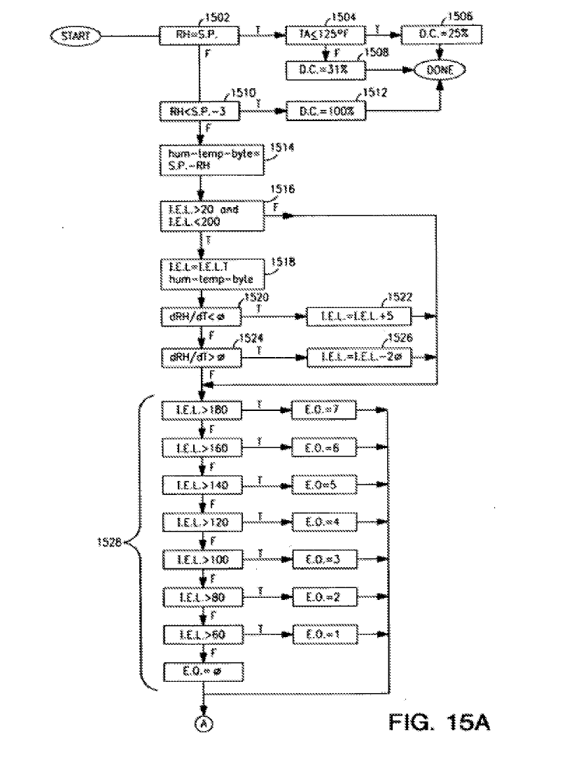

According to an embodiment of the present invention, the humidity control method consists of three states: Idle, Increase Humidity, and Decrease Humidity. Referring to FIG. 14A, a humidity regulation state diagram is provided. In the decrease humidity state, the vent is either open 50% or 100%, depending on how far the actual humidity is above the set point. Other opening percentages may be used as desired. FIG. 14B provides a graphical representation of the humidity regulation.

In addition, the control levels of SP+9% RH and SP+7% just amount to a hysteresis band that switches between about 50% and about 100% vent opening.

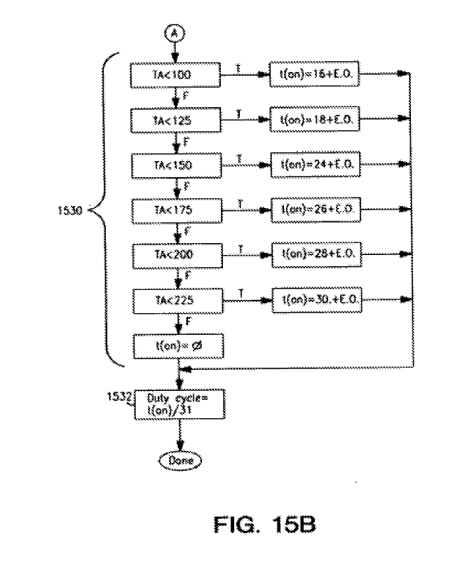

In the Increase Humidity state, the net result of the flow chart logic is to determine a duty cycle setting for the water heat output. The duty cycle is the number of 1/16 second intervals, out of a period of 2 seconds that the water heat is on. For example, in a duty cycle of 25%, the heat is on for 0.5 seconds, which corresponds to 8 intervals of 1/16 second. Referring to FIG. 15, a flowchart depicting the Increase Humidity logic according to one embodiment of the present invention is provided.

The humidity control is similar to PID control, but the derivative information is only used to update the integral term.

Blocks 1502 to 1508 set the water heat duty cycle when the actual humidity is the same as the set point. When the temperature is below 125° F., the duty cycle is set to 25%. When the temperature is above 125° F., the duty cycle is set to 31%. These cycles act to maintain the humidity near the set point. A higher duty cycle is needed at higher temperatures. Blocks 1510 and 1512 set the duty cycle to 100% (full on) when the actual humidity is more than 3% RH below the humidity set point. This acts to bring the humidity back to the set point. Block 1514 calculates the humidity error (humidity set point-actual humidity) and saves it in a variable called hum_temp_byte.

Blocks 1516-1526 adjust the integral correction term I.E.L (which stands for the code variable integral_error_level). The test in block 1516 limits I.E.L. to values of 20 and 200. Block 1518 adds the humidity error to I.E.L. Blocks 1520 to 1526 add 5 to I.E.L. when the humidity is decreasing, and subtract 20 from I.E.L. when the humidity is increasing.

The initialization of I.E.L. is not shown, but I.E.L. is set to zero whenever the Increase Humidity state is entered, or whenever the measured humidity equals the set point.

The blocks in 1528 set a new variable, E.O. (for error_offset) from the value of I.E.L. just found. Note that a larger value of I.E.L. results in a larger value of E.O.

The blocks in 1530 find the duty-cycle on-time, called t(on). t(on) is a function of E.O. and the air temperature Ta. t(on) is just the sum of a constant that depends on the air temperature and the value of E.O.

Blocks 1532 show that the actual duty cycle is calculated from t(on)/31. The divisor is “31” because a 16 Hz clock is used for the water heat output. The duty-cycle period is 2 seconds, but the clock actually counts from 0 to 31.

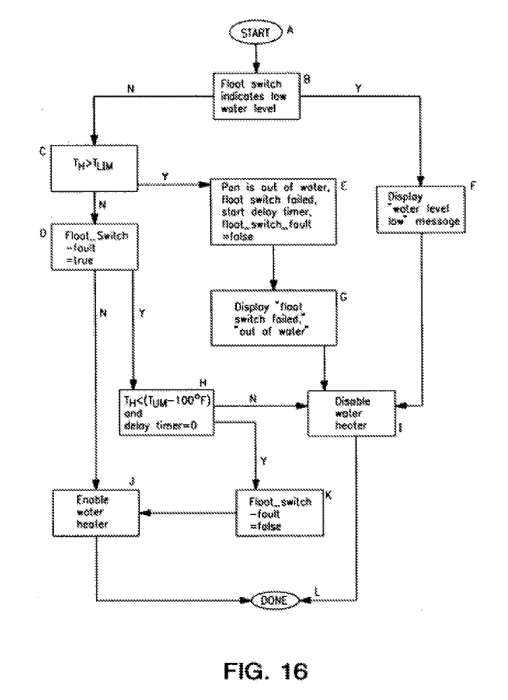

Referring to FIG. 16, a flow chart of the operation of a closed-loop humidity control system is depicted. In this chart, T_{H} is the water pan heater temperature measured by water pan heater temperature sensor 723, and T_{UM} is the maximum allowable water pan temperature. A Float-Switch-Fault is true when float switch 720 has failed. Float switch 720 has failed when it fails to accurately detect significant changes in the water level in water pan 716.

Various operational conditions are detailed with respect to FIG. 16. when water pan 716 is found empty during normal operations, float switch 720 will indicate allow water level (Step B) and a “low water level” message is displayed (Step F). Water pan heater 722 then will be disabled (Step I), and control system 700 will complete its operation (Step L).

Similarly, when water pan 716 is incorrectly found empty during normal operations, float switch 720 again will indicate a low water level (Step B). However, control system 700 will inquire whether T_{H}>T_{LIM} (Step C). When T_{H}≦T_{LIM}, the Float-Switch-Fault is true (Step D), and water pan heater 722 is enabled (Step J). Control system 700 then again completes its operation (Step L).

If a Float-Switch-Fault is detected, a low water level is again detected (Step B) and control system 700 again will inquire whether T_{H}>T_{LIM} (Step C). When T_{H}>T_{LIM}, then water pan 716 is empty or low on water and Float-Switch-Fault is true (Step E). The display may then indicate “Float Switch Failed” and “Out of Water” or “Pan Empty” (Step G). Water pan heater 722 will be disabled (Step I), and control system 700 will complete its operation (Step L).

While waiting for a Float-Switch-Fault to clear, Float switch 720 will initially indicate that the water level in water pan 716 is low (Step B). Control system 700 then will inquire whether T_{H}>T_{LIM} (Step C). When T_{H}≦T_{LIM}, Float-Switch-Fault is true (Step D), and, when T_{H}>(T_{LIM}−100° F.) or the reset delay timer is not set to zero (Step H), water pan heater 722 is disabled (Step I). Control system 7800 then will complete its operation (Step L).

Once the Float-Switch-Fault has cleared, when Float switch 720 indicates that the water level in water pan 716 is low (Step B), control system 700 inquires whether T_{H}>T_{LIM} (Step C). When T_{H}≦T_{LIM}, Float-Switch-Fault is true (Step D), and control system 700 inquires whether T_{H}>(T_{LIM}−100° F.) and whether the reset delay timer is set to zero. (Step H). When both of these conditions exist, the Float-Switch-Fault is false (Step K), and water pan heater 722 is enabled (Step J). Control system 700 then will complete its operation (Step L).

In particular configurations, as described in more detail below with respect to FIGS. 19A and 19B, one or more mist generators 1900 may be used in place of or in addition to water pan 716, water pan heater 722, water pan heater temperature sensor 723, and float switch 720. Such mist generators 1900 may be operated in conjunction with vent position switch 732, air fan 708, and air heater 706 to extend the time period during which the quality of food held in holding cabinet 100 remains acceptable. The duty cycles and on/off states of the one or more mist generators 1900 may be substantially the same as the duty cycles and on/off states of water pan heater 722 described above, and electrodes 1932 and 1934 may provide functionality similar to that of float switch 720.

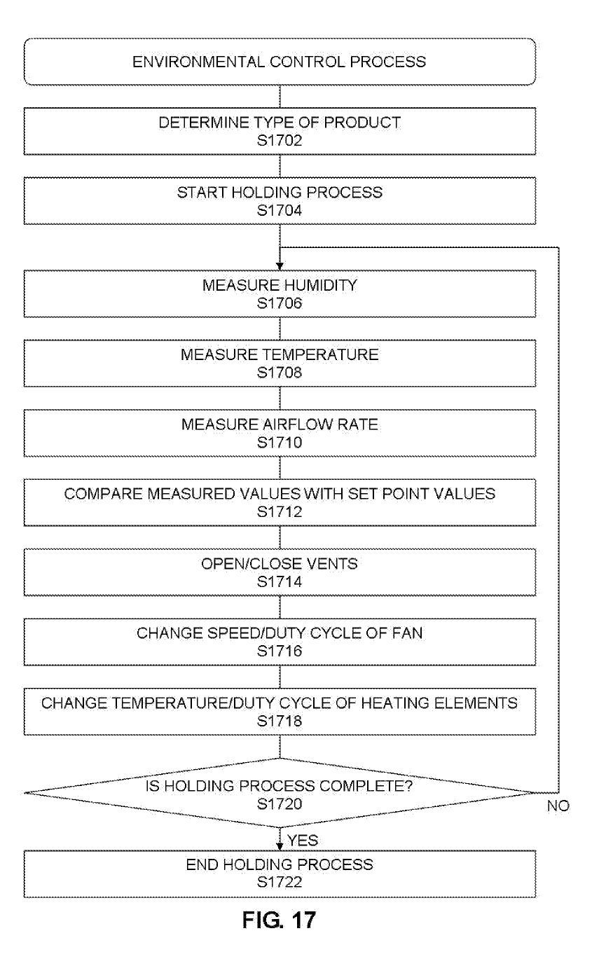

FIG. 17 depicts an environmental control process for controlling the environmental conditions in the holding cabinet. In particular configurations, the environmental process, which may be controlled by a controller such as controller 121 (described below), may utilize at least one set point value corresponding to the type of food product to be held in holding cabinet 100. Specifically, in S1702, controller 121 may determine the type of product to be held in holding cabinet 100. For example, controller 121 may make this determination based on a selection input through a control panel or by a signal transmitted from a computer. Thereafter, controller 121 may select a predetermined set point value, which may be stored in a memory such as memory 125 (described below), for the determined type of food product to be held in holding cabinet 100. In particular configurations, the selected predetermined set point value may correspond to a value of one or more of temperature, humidity, and airflow rate, alone or in combination, which has been determined to extend the holding time of the determined type of food product before its quality degrades significantly as compared to other such values of the one or more of temperature, humidity, and airflow rate, alone or in combination. In addition, the set point may correspond to particular ranges about the one or more of temperature, humidity, and airflow rate, which have been determined to extend the holding time of the determined type of food product before its quality degrades significantly as compared to other such values of the one or more of temperature, humidity, and airflow rate, alone or in combination. In certain configurations, the set point may be selected without determining a product load (e.g., the amount of the food product to be held in holding cabinet 100).

Thereafter, the process may proceed to S1704, and the holding process may start. During the holding process, humidity sensor 704 may measure the humidity of the air in holding cabinet 100 in S1706, air temperature probe 702 may measure the temperature of the air in holding cabinet 100 in S1708, and airflow sensor 709 may measure the airflow rate of the air in holding cabinet 100 in S1710. As indicated above, S1706, S1708, and S1710 may be performed in any order, or even concurrently, and certain of S1706, S1708, and S1710 may be omitted in some configurations. Humidity sensor 704, air temperature probe 702, and airflow sensor 709 may transmit the measured values of humidity, temperature, and airflow rate, respectively, to controller 121.

Thereafter, controller 121 may compare the measured values of humidity, temperature, and airflow rate with the respective values or ranges of humidity, temperature, and airflow rate corresponding to the selected set point value in S1712. Each of S1714, S1716, and S1718 may be performed in accordance with the result of the comparisons performed in S1712. As indicated above, S1714, S1716, and S1718 may be performed in any order, or even concurrently, and certain of S1714, S1716, and S1718 may be omitted in some configurations.

In S1714, controller 121 may selectively control vent position switch 732, such that the vents in holding cabinet 100 are selectively opened and closed based on a result of the comparisons performed in S1712. S1714 may be substantially similar to the processes described with respect to FIG. 14A above, except that the vents may also be selectively opened and closed based on one or more of the measured values of temperature and airflow rate, as well as the measured value of humidity. For example, when it is determined in S1712 that the measured humidity is greater than the humidity value (or the upper limit of the humidity range, when ranges are provided) corresponding to the selected set point or that the measured temperature is greater than the temperature value (or the upper limit of the temperature range, when ranges are provided) corresponding to the selected set point, controller 121 may control vent position switch 732 to open the vents in S1714. Conversely, for example, when it is determined in S1712 that the measured humidity is less than or equal to the humidity value (or the lower limit of the humidity range, when ranges are provided) corresponding to the selected set point or that the measured temperature is less than or equal to the temperature value (or the lower limit of the temperature range, when ranges are provided) corresponding to the selected set point, controller 121 may control vent position switch 732 to close the vents in S1714. The amount of opening or closing of the vents may be proportional to the deviation of the measured values from the values (or range limits) corresponding to the set point value, and may be further informed by the measured airflow rate (e.g., when the measured airflow rate is high, there may be more convective cooling of the product and the vents may not need to be opened as far to reduce the temperature). Further, controller 121 may change one or more of the frequency and duration (e.g., the duty cycle) of opening and closing the vents based on the deviation of the measured values from the values (or range limits) corresponding to the set point value.

In S1716, controller 121 may selectively control air fan 708, such that the airflow rate in holding cabinet 100 is selectively changed based on a result of the comparisons performed in S1712. For example, when it is determined in S1712 that the measured temperature is greater than the temperature value (or the upper limit of the temperature range, when ranges are provided) corresponding to the selected set point or that the measured airflow rate is less than the airflow rate (or the lower limit of the airflow rate range, when ranges are provided) corresponding to the selected set point, controller 121 may activate air fan 708 or increase the speed of air fan 708 in proportion to the deviation of the measured values from the values (or range limits) corresponding to the set point value. Conversely, for example, when it is determined in S1712 that the measured temperature is less than or equal to the temperature value (or the lower limit of the temperature range, when ranges are provided) corresponding to the selected set point or that the measured airflow rate is greater than the airflow rate (or the upper limit of the airflow rate range, when ranges are provided) corresponding to the selected set point, controller 121 may deactivate air fan 708 or decrease the speed of air fan 708 in proportion to the deviation of the measured values from the values (or range limits) corresponding to the set point value. Further, controller 121 may change one or more of the frequency and duration (e.g., the duty cycle) of activating and deactivating air fan 708 based on the deviation of the measured values from the values (or range limits) corresponding to the set point value.

In S1718, controller 121 may selectively control one or more of air heater 706 and water pan heater 722, such that a corresponding one or more of the temperature of the air in holding cabinet 100 and the humidity (e.g., by selectively generating water vapor via evaporation of water in water pan 716 implemented through selective activation of water pan heater 722) of air in holding cabinet 100 is changed based on a result of the comparisons performed in S1712.

For example, substantially similar to the process described above with respect to FIG. 16, when it is determined in S1712 that the measured humidity is greater than the humidity value (or the upper limit of the humidity range, when ranges are provided) corresponding to the selected set point, controller 121 may control water pan heater 722 to deactivate or to generate less heat in S1718. Conversely, for example, when it is determined in S1712 that the measured humidity is less than the humidity value (or the lower limit of the humidity range, when ranges are provided) corresponding to the selected set point, controller 121 may control water pan heater 722 to activate or to generate more heat in S1718. The amount of heat generated by water pan heater 722 may be proportional to the deviation of the measured values from the values (or range limits) corresponding to the set point value, and may be further informed by the measured airflow rate (e.g., when the measured airflow rate is high, there may be more convective cooling of the product and water pan heater 722 may need to generate more heat to cause a phase change in the water). Further, controller 121 may change one or more of the frequency and duration (e.g., the duty cycle) of activation of water heater pan 722 based on the deviation of the measured values from the values (or range limits) corresponding to the set point value.

Further, for example, when it is determined in S1712 that the measured temperature is greater than the temperature value (or the upper limit of the temperature range, when ranges are provided) corresponding to the selected set point or that the measured airflow rate is less than the airflow rate (or the upper limit of the airflow rate range, when ranges are provided) corresponding to the selected set point, controller 121 may control air heater 706 to deactivate or to generate less heat in S1718. Conversely, for example, when it is determined in S1712 that the measured temperature is less than or equal to the temperature value (or the lower limit of the temperature range, when ranges are provided) corresponding to the selected set point or that the measured airflow rate is greater than the airflow rate (or the upper limit of the airflow rate range, when ranges are provided) corresponding to the selected set point, controller 121 may control air heater 706 to activate or to generate more heat in S1718. The amount of heat generated by air heater 706 may be proportional to the deviation of the measured values from the values (or range limits) corresponding to the set point value, and may be further informed by the measured airflow rate (e.g., when the measured airflow rate is high, there may be more convective cooling of the product and the vents may not need to be opened as far to reduce the temperature). Further, controller 121 may change one or more of the frequency and duration (e.g., the duty cycle) of activation of air heater 706 based on the deviation of the measured values from the values (or range limits) corresponding to the set point value.

After one or more of S1714, S1716, and S1718 is completed, controller 121 may determine whether the holding process is complete in S1720. When controller 121 determines that the holding process is not complete (S1720: NO) (e.g., when there is no indication that the holding process is complete), the environmental control process returns to one or more of S1706, S1708, and S1710. In this manner, controller 121 may implement a feedback loop that controls the environmental conditions within holding cabinet 100 by periodically monitoring the humidity of air in holding cabinet 100, the temperature of air in holding cabinet 100, and the airflow rate in holding cabinet 100, which may help to maintain or reduce the degradation of the quality of the held product over an extended period of time.

In particular configurations, controller 121 may determine that the holding process is complete (S1720: YES) when the food product has been held for a certain period of time (e.g., a predetermined period of time corresponding to a length of time over which the quality of the food product would degrade significantly leading to poor taste or texture, a predetermined amount of time selected at the beginning of the holding process), at a certain time of day (e.g., at the close of business, at a transition time between breakfast and lunch, at a predetermined time selected at the beginning of the holding process), or when a particular event occurs (e.g., holding cabinet 100 is opened, water pan 716 runs out of water, a component of holding cabinet 100 or controller 121 malfunctions). When controller 121 determines that the holding process is complete (S1720: YES), controller 121 may end the holding process in S1722 and the environmental control process may end. When controller 121 ends the holding process in S1722, controller may, for example, deactivate one or more of air heater 706, air fan 708, and water pan heater 722.

In particular configurations, the memory may store a plurality of set point values, each of which may correspond to a predetermined range, within which at least one of the temperature, the humidity, and the airflow rate in the holding cabinet is to be maintained. In some configurations, each set point value, and each predetermined range corresponding to the set point, may be associated with a particular food product. In this manner, the environmental conditions for different food products, which may have different material properties, may be maintained in a manner that may be particularly suited for that product and that may extend the holding time before significant degradation of that product's quality occurs. For example, one set point may be associated with chicken nuggets, while another set point may be associated with churros (e.g., Spanish doughnuts). In this manner, the system may use an appropriate set point for a particular food product, which may further extend the holding time for that particular food product before significant degradation of quality occurs, after the system determines the type of the particular food product held or to be held in the holding cabinet.

In certain configurations, the memory may store a plurality of set point values which may be utilized at different times during the holding process. For example, one set point may be utilized for the first five minutes of holding, and another set point may be utilized for the remainder of the holding period. In still other configurations, different set points may be utilized upon the occurrence of different events. For example, one set point may be utilized when the food product is initially placed in the cabinet, and another set point may be utilized when a cabinet door is opened.

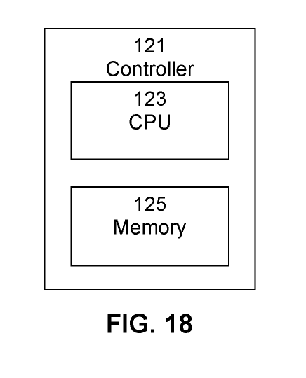

Holding cabinet 100 may include a controller 121 disposed therein. In other configurations, controller 121 may be external to holding cabinet 100. As shown in FIG. 18, controller 121 includes a central processing unit (“CPU”) 123 and a memory 125. Memory 125 may be a non-transitory memory device, examples of which may include: one or more of a solid state drive, a hard drive, a random access memory, read-only memory, or other memory device, that may store computer-readable instructions for execution by CPU 123. When CPU 123 executes the computer-readable instructions stored in memory 125, the instructions may instruct CPU 123 to control the functions of holding cabinet 100 described herein. Specifically, controller 121 may be configured to control the operations of the components of holding cabinet 100. In some configurations, each of a plurality of controllers 121 may control a different operation or component of holding cabinet 100.

Although particular configurations disclosed above may utilize a process of heating water stored in a water pan near the bottom of the holding cabinet, certain configurations may utilize other humidity-generation means alone or in combination with such a water pan. For example, the holding cabinet may comprise a steam generator, which may generate humidity in the holding cabinet. Further, such a steam generator, for example, may be configured to discharge steam at various locations throughout the holding cabinet (e.g., positions along the sides of the holding cabinet, positions at the top of the holding cabinet, positions at the bottom of the holding cabinet), and steam discharge ports may be oriented to circulate steam at various angles in various directions throughout the holding cabinet. In addition, other humidity generation methods may be utilized to generate humidity in the holding cabinet.

For example, FIG. 19A shows an exploded view of an embodiment of a mist generator 1900 that may be used as a humidity generation system in place of or in addition to the combination of water pan 716, water pan heater 722, water pan heater temperature sensor 723, and float switch 720. Mist generator 1900 may include a heater 1902, a base portion 1927, a wick device 1912, a holder 1914, a fluid reservoir 1916, fluid ports 1918 and 1926, a lower electrode 1932, and an upper electrode 1934. In certain configurations, Mist generator 1900 may include a dedicated controller 1940, which may receive information from and control one or more of heater 1902, lower electrode 1932, upper electrode 1934, and a pump 1920 configured to pump fluid into fluid reservoir 1916 through fluid port 1918. Controller 1940 may be connected with controller 121. In certain configurations, one or more controllers 121 may directly connect with and control one or more of the components of mist generator 1900, in which case controller 1940 may be omitted. The fluid utilized by mist generator 1900 may be, for example, water, but other fluids may be used in place or in addition to water.

As noted above, mist generator 1900 may include a fluid reservoir 1916. Fluid reservoir 1916 may be supported by base portion 1927, which may include a lower plate 1928 having an outer diameter that is greater than or equal to the outer diameter of fluid reservoir 1916 and an internal wall 1929 extending from the lower plate 1928 in an axial direction of mist generator 1900. Internal wall 1929 may have an outer diameter that is less than an inner diameter of fluid reservoir 1916 and may have a length in the axial direction that is less than the length of fluid reservoir 1916 in the axial direction. Further, internal wall 1929 may form a plurality of slots 1924 that may permit fluid communication through internal wall 1929. The base of fluid reservoir 1916 may contact lower plate 1928 and a fluid-tight seal may be formed therebetween.

Base portion 1927 also may support holder 1914. In some configurations, holder 1914 may have substantially the same diameter as internal wall 1929 and may be supported within fluid reservoir 1916 by the upper edge of internal wall 1929 in the axial direction. In other configurations, holder 1914 may have an outer diameter that is less than or equal to the inner diameter of internal wall 1929 and may be supported by lower plate 1928 within internal wall 1929 and fluid reservoir 1916. In particular configurations, holder 1914 may extend at least as far as the upper edge of fluid reservoir 1916 in the axial direction.

Wick device 1912 may have an outer diameter that is less than or equal to an inner diameter of holder 1914 and may be disposed within an inner space formed by holder 1914. Wick device 1912 may extend at least as far as the upper edge of one or more of fluid reservoir 1916 and holder 1914 in the axial direction. Holder 1914 may include a plurality of holes or perforations formed therein that may permit fluid to pass through holder 1914 to wick device 1912. Such holes and perforations may be formed on only a portion of holder 1914 or may be formed over the entirety of holder 1914. In particular configurations, holder 1914 may be a porous material that may permit fluid to pass through to wick device 1912. In some configurations, wick device 1912 may be formed of or may include one or more strands of a flexible rope-like material. In some configurations, the flexible rope-like material may even have a pipe-cleaner-like appearance. Consequently, holder 1914 may be formed of a rigid material to assist in supporting wick device 1912 in such configurations. In other configurations, wick device 1912 may be formed of a porous ceramic material. In such configurations, wick device 1912 may be sufficiently rigid such that holder 1914 may be omitted and wick device 1912 may be disposed within the inner space formed by fluid reservoir 1916.

Heater 1902 may be supported by at least one of wick device 1912, holder 1914, and fluid reservoir 1916. Heater 1902 may be a thin disc or may be formed as a film in some configurations. Heater 1902 may include a single hole in its center from which steam or mist may be released in the axial direction. In some configurations, the diameter of heater 1902 may be less than the diameter of wick device 1912 such that steam or mist may be released around the perimeter of heater 1902, as well as at its center. In such configurations, heater 1902 may be formed as a film on wick device 1912.

As noted above, mist generator 1900 may include a lower (e.g., closer to lower plate 1928 in the axial direction than electrode 1934) electrode 1932, an upper (e.g., further from lower plate 1928 in the axial direction than electrode 1932) electrode 1934, and fluid ports 1918 and 1926. Fluid port 1918 may be in fluid communication with pump 1920, which may be in fluid communication with a fluid source 1922. Controller 1940 may selectively control pump 1920 to pump fluid into fluid reservoir 1916 via fluid port 1918. Accordingly, fluid port 1918 may act as a fluid inlet port.

Fluid port 1926 may include a valve (not shown) or cap (not shown) that may be opened or closed to permit fluid to drain therefrom out of fluid reservoir 1916. The valve or cap may be controlled by controller 1940 or may be controlled manually. Fluid port 1926 may be used to drain fluid reservoir 1916 for cleaning, for example. In other configurations, fluid port 1926 may be omitted and fluid port 1918 may function as both a fluid inlet port and a fluid outlet port.

Electrodes 1932 and 1934 may be used to sense the level of fluid in fluid reservoir 1916. For example, upper electrode 1934 may act as a high level sensor that may produce a characteristic signal when the level of fluid in fluid reservoir 1916 rises to a first level and lower electrode 1932 may act as a low level sensor that may produce a characteristic signal when the level of fluid in fluid reservoir 1916 falls below a send level. In particular, when the level of fluid in fluid reservoir 1916 is at a third level between the first level and the second level, fluid may be sensed by (e.g., in contact with) lower electrode 1932, such that lower electrode 1932 produces a first characteristic signal, and fluid may not be sensed by (e.g., not in contact with) upper electrode 1934, such that upper electrode 1934 produces a second characteristic signal. When controller 1940 receives both the first and second characteristic signals, controller 1940 may determine that the fluid level is acceptable (e.g., between the first and second levels).

When the fluid level rises above the first level, fluid may be sensed by (e.g., in contact with) both electrodes 1932 and 1934, such that both electrodes 1932 and 1934 produce the first characteristic signal. When controller 1940 receives the first characteristic signal from both electrodes 1932 and 1934, controller 1940 may determine that the fluid level is high (e.g., at or above the first level). Consequently, controller 1940 may perform an action such as opening the valve or cap at fluid port 1926 to drain fluid from fluid reservoir 1916, using pump 1920 to pump fluid out of fluid reservoir 1916 via fluid port 1918, energizing heater 1902 to rapidly create steam or mist and venting the steam or mist appropriately, or some combination of these actions.

When the fluid level falls below the second level, fluid may not be sensed by (e.g., not in contact with) both electrodes 1932 and 1934, such that both electrodes 1932 and 1934 produce the second characteristic signal. When controller 1940 receives the second characteristic signal from both electrodes 1932 and 1934, controller 1940 may determine that the fluid level is low (e.g., at or below the first level). Consequently, controller 1940 may perform an action such as controlling pump 1920 to pump additional fluid into fluid reservoir 1916 via fluid port 1918, deactivating heater 1902 to prevent further fluid loss or damage to mist generator 1900, or some combination of these actions.

The operation of mist generator 1900 now is described. In response to determining that additional humidity is needed in cabinet 100 (e.g., via a signal from controller 121), controller 1940 may determine whether the level of fluid in fluid reservoir 1916 is between the first level and the second level based on the signals produced by electrodes 1932 and 1934 and, if necessary, will adjust the amount of fluid in reservoir 1916, as described above, to ensure that the level of fluid in fluid reservoir 1916 is between the first level and the second level. Fluid in reservoir 1916 may move through one or more of internal wall 1929 (e.g., through slots 1924) and holder 1914 (e.g., through the perforations therein) toward wick device 1912. Specifically, capillary action may draw the fluid from reservoir 1916 toward wick device 1912. Further, capillary action may draw the fluid along wick device 1912 in the axial direction toward heater 1902. Controller 1940 may activate heater 1902, and heater 1902 may generate heat, which may cause the fluid in the wick device 1912 to evaporate into steam or mist. The steam or mist may be released from mist generator 1900 via the central hole in heater 1902 or at the perimeter of heater 1902. Consequently, the release of the steam or mist and the resulting loss of fluid at the end of wick device 1912 will allow more fluid from reservoir 1916 to be drawn toward wick device 1912 and upward toward heater 1902. Controller 1940 may continue this process until controller 1940 determines that additional humidity is not currently needed. Throughout this process, controller 1940 may maintain the level of fluid in reservoir 1916 between the first and second levels to ensure satisfactory operation of mist generator 1900 and to avoid potential damage.

FIG. 19B shows an exploded view of another embodiment of mist generator 1900. The embodiment shown in FIG. 19B is substantially the same as the embodiment shown in FIG. 19A, except that FIG. 19B shows a heater 1904, rather than heater 1902. As such, like numerals are used to represent substantially similar components. Heater 1904 may be formed of an efficient thermal conductor, such as aluminum, for example. Heater 1904 may have a diameter that is greater than the diameter of one or more of wick device 1912 and holder 1914 and may have a thickness in the axial direction that is much greater than the thickness of heater 1902. In some configurations, heater 1904 may even be supported by an upper edge of fluid reservoir 1916 in the axial direction. In certain configurations, the fluid reservoir 1916 and a base or side of heater 1904 may form a fluid-tight seal therebetween, such that steam or mist may not be released at the perimeter of heater 1904. Further, heater 1904 may include a plurality of holes formed therein in the axial direction from which steam or mist may be released. The mist generator 1900 shown in FIG. 19B may otherwise function similarly to the mist generator 1900 shown in FIG. 19A.

In contrast to the present invention, known humidifying devices have heated pools of water to generate steam, which makes humidity in cabinet. This kind of steam makes large droplets of water and may be unevenly distributed on food products. This type of device also may need a significant amount of time to produce steam and may consume a relatively large amount of electrical energy. Accordingly, mist generator 1900 may address these and other problems.

Mist generator 1900 provides many advantages over known systems. For example, mist generator 1900 may generate mist within a few seconds compared with the more significant amount of time required to heat up a large pool of water. Further, mist generator 1900 may use less electricity energy to generate mist than known methods. In addition, mist generated by mist generator 1900 may be finer than that produced when heating up a large pool of water. Moreover, mist generator 1900 may generate mist on command when there is a demand and may be deactivated quickly, such that mist may be generated only when there is a demand in contrast to known methods which may require a substantial lag time.

Consequently, cabinet 100 may include mist generator 1900 to provide mist to humidify the foods held in cavities therein. By controlling the level of fluid in fluid reservoir 1916, mist generator 1900 may maintain an appropriate amount of water in wick device 1912, and controller 1940 may energize heater 1902 or 1904 to produce mist that is transferred to the food in the cavity via the above-described plumbing that may distribute the mist evenly in cabinet 100.

Thus, the structure of mist generator 1900 may permit the wicking (e.g., capillary) action of the moisture wicking in porous ceramic, such as wick device 1912, to moisture or other fluid to the top surface of wick device 1912 beneath heater 1902 or 1904. As noted above, the wick device may, for example, be made of a porous wicking material that may absorb water from the reservoir and may provide a sufficient surface area for the moisture to evaporate therefrom. In some configurations, such a porous material may include a number of cotton strands (or strands made from another fibrous or flexible material) extending the length of the wicking device, such that the strands are adapted to supply fluid from fluid reservoir 1916 to heater 1902 or 1904 via a capillary action. Such strands may have a rope-like appearance. In particular configurations, the strands may be packed together in a rigid outer shell to form wicking device 1912. In other configurations, the wicking material may, for example, be made of a ceramic material, which may, in certain configurations thereof, be rigid and self-supporting.

While mist generator 1900 is described in the context of a holding cabinet above, mist generator 1900 may be used in any system or application in which generating steam or a mist from liquid is desired.

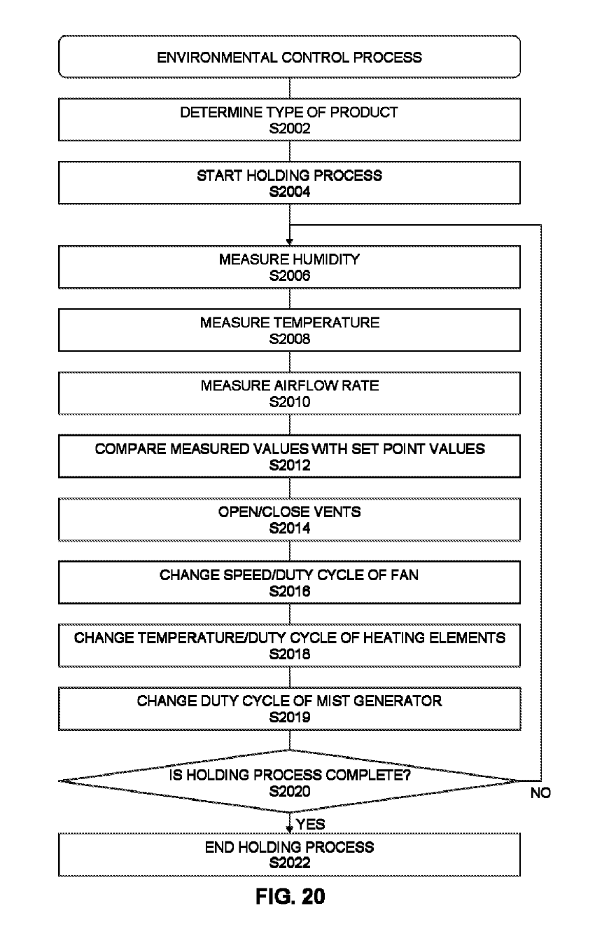

FIG. 20 shows an environmental control process for controlling the environmental conditions in the holding cabinet that is substantially similar to the environmental control process depicted in FIG. 17, with the exception that the environmental control process of FIG. 20 may utilize one or more mist generators 1900 in place of or in addition to water pan 716, water pan heater 722, water pan heater temperature sensor 723, and float switch 720. Consequently, processes S1702, S1704, S1706, S1708, S1710, S1712, S1714, S1716, S1720, and S1722 may be substantially similar to processes S2002, S2004, S2006, S2008, S2010, S2012, S2014, S2016, S2020, and S2022. S2018 may be different from S1718, as described above, if water pan 716 and water pan heater 722 are omitted. The processes shown in FIG. 20 also include S2019, which is a process of controlling the operation (e.g., on/off state and duty cycle) of mist generator 1900.

In particular configurations, the environmental process of FIG. 20, which may be controlled by a controller such as controller 121, may utilize at least one set point value corresponding to the type of food product to be held in holding cabinet 100. Specifically, in S2002, controller 121 may determine the type of product to be held in holding cabinet 100. For example, controller 121 may make this determination based on a selection input through a control panel or by a signal transmitted from a computer. Thereafter, controller 121 may select a predetermined set point value, which may be stored in a memory such as memory 125 (described below), for the determined type of food product to be held in holding cabinet 100. In particular configurations, the selected predetermined set point value may correspond to a value of one or more of temperature, humidity, and airflow rate, alone or in combination, which has been determined to extend the holding time of the determined type of food product before its quality degrades significantly as compared to other such values of the one or more of temperature, humidity, and airflow rate, alone or in combination. In addition, the set point may correspond to particular ranges about the one or more of temperature, humidity, and airflow rate, which have been determined to extend the holding time of the determined type of food product before its quality degrades significantly as compared to other such values of the one or more of temperature, humidity, and airflow rate, alone or in combination. In certain configurations, the set point may be selected without determining a product load (e.g., the amount of the food product to be held in holding cabinet 100).

Thereafter, the process may proceed to S2004, and the holding process may start. During the holding process, humidity sensor 704 may measure the humidity of the air in holding cabinet 100 in S2006, air temperature probe 702 may measure the temperature of the air in holding cabinet 100 in S2008, and airflow sensor 709 may measure the airflow rate of the air in holding cabinet 100 in S2010. As indicated above, S2006, S2008, and S2010 may be performed in any order, or even concurrently, and certain of S2006, S2008, and S2010 may be omitted in some configurations. Humidity sensor 704, air temperature probe 702, and airflow sensor 709 may transmit the measured values of humidity, temperature, and airflow rate, respectively, to controller 121.

Thereafter, controller 121 may compare the measured values of humidity, temperature, and airflow rate with the respective values or ranges of humidity, temperature, and airflow rate corresponding to the selected set point value in S2012. Each of S2014, S2016, S2018, and S2019 may be performed in accordance with the result of the comparisons performed in S2012. As indicated above, S2014, S2016, S2018, and S2019 may be performed in any order, or even concurrently, and certain of S2014, S2016, S2018, and S2019 may be omitted in some configurations.

In S2014, controller 121 may selectively control vent position switch 732, such that the vents in holding cabinet 100 are selectively opened and closed based on a result of the comparisons performed in S2012. S2014 may be substantially similar to the processes described with respect to FIG. 14A above, except that the vents may also be selectively opened and closed based on one or more of the measured values of temperature and airflow rate, as well as the measured value of humidity. For example, when it is determined in S2012 that the measured humidity is greater than the humidity value (or the upper limit of the humidity range, when ranges are provided) corresponding to the selected set point or that the measured temperature is greater than the temperature value (or the upper limit of the temperature range, when ranges are provided) corresponding to the selected set point, controller 121 may control vent position switch 732 to open the vents in S2014. Conversely, for example, when it is determined in S2012 that the measured humidity is less than or equal to the humidity value (or the lower limit of the humidity range, when ranges are provided) corresponding to the selected set point or that the measured temperature is less than or equal to the temperature value (or the lower limit of the temperature range, when ranges are provided) corresponding to the selected set point, controller 121 may control vent position switch 732 to close the vents in S2014. The amount of opening or closing of the vents may be proportional to the deviation of the measured values from the values (or range limits) corresponding to the set point value, and may be further informed by the measured airflow rate (e.g., when the measured airflow rate is high, there may be more convective cooling of the product and the vents may not need to be opened as far to reduce the temperature). Further, controller 121 may change one or more of the frequency and duration (e.g., the duty cycle) of opening and closing the vents based on the deviation of the measured values from the values (or range limits) corresponding to the set point value.

In S2016, controller 121 may selectively control air fan 708, such that the airflow rate in holding cabinet 100 is selectively changed based on a result of the comparisons performed in S2012. For example, when it is determined in S2012 that the measured temperature is greater than the temperature value (or the upper limit of the temperature range, when ranges are provided) corresponding to the selected set point or that the measured airflow rate is less than the airflow rate (or the lower limit of the airflow rate range, when ranges are provided) corresponding to the selected set point, controller 121 may activate air fan 708 or increase the speed of air fan 708 in proportion to the deviation of the measured values from the values (or range limits) corresponding to the set point value. Conversely, for example, when it is determined in S2012 that the measured temperature is less than or equal to the temperature value (or the lower limit of the temperature range, when ranges are provided) corresponding to the selected set point or that the measured airflow rate is greater than the airflow rate (or the upper limit of the airflow rate range, when ranges are provided) corresponding to the selected set point, controller 121 may deactivate air fan 708 or decrease the speed of air fan 708 in proportion to the deviation of the measured values from the values (or range limits) corresponding to the set point value. Further, controller 121 may change one or more of the frequency and duration (e.g., the duty cycle) of activating and deactivating air fan 708 based on the deviation of the measured values from the values (or range limits) corresponding to the set point value.

In S2018, controller 121 may selectively control air heater 706 and, if utilized, water pan heater 722, such that a corresponding one or more of the temperature of the air in holding cabinet 100 and, if water pan heater 722 is utilized, the humidity (e.g., by selectively generating water vapor via evaporation of water in water pan 716 implemented through selective activation of water pan heater 722) of air in holding cabinet 100 are changed based on a result of the comparisons performed in S2012.

Further, for example, when it is determined in S2012 that the measured temperature is greater than the temperature value (or the upper limit of the temperature range, when ranges are provided) corresponding to the selected set point or that the measured airflow rate is less than the airflow rate (or the upper limit of the airflow rate range, when ranges are provided) corresponding to the selected set point, controller 121 may control air heater 706 to deactivate or to generate less heat in S2018. Conversely, for example, when it is determined in S2012 that the measured temperature is less than or equal to the temperature value (or the lower limit of the temperature range, when ranges are provided) corresponding to the selected set point or that the measured airflow rate is greater than the airflow rate (or the upper limit of the airflow rate range, when ranges are provided) corresponding to the selected set point, controller 121 may control air heater 706 to activate or to generate more heat in S2018. The amount of heat generated by air heater 706 may be proportional to the deviation of the measured values from the values (or range limits) corresponding to the set point value, and may be further informed by the measured airflow rate (e.g., when the measured airflow rate is high, there may be more convective cooling of the product and the vents may not need to be opened as far to reduce the temperature). Further, controller 121 may change one or more of the frequency and duration (e.g., the duty cycle) of activation of air heater 706 based on the deviation of the measured values from the values (or range limits) corresponding to the set point value.

In addition, substantially similar to the process described above with respect to FIGS. 16 and 17, when it is determined in S2012 that the measured humidity is greater than the humidity value (or the upper limit of the humidity range, when ranges are provided) corresponding to the selected set point, controller 121 may control heater 1902 to deactivate or to generate less heat in S2019. Conversely, for example, when it is determined in S2012 that the measured humidity is less than the humidity value (or the lower limit of the humidity range, when ranges are provided) corresponding to the selected set point, controller 121 may heater 1902 to activate or to generate more heat in S2019. The amount of heat generated by heater 1902 may be proportional to the deviation of the measured values from the values (or range limits) corresponding to the set point value, and may be further informed by the measured airflow rate (e.g., when the measured airflow rate is high, there may be more convective cooling of the product and heater 1902 may need to generate more heat to cause a phase change in the water). Further, controller 121 may change one or more of the frequency and duration (e.g., the duty cycle) of activation of heater 1902 based on the deviation of the measured values from the values (or range limits) corresponding to the set point value.

In certain configurations, in S2019, controller 121 may determine an amount of mist to be generated by mist generator 1900 based on one or more of the comparison in S2012 between one or more of the humidity measured in S2006, the temperature measured in S2008, and the airflow rate measured in S2010 and the set point values; an amount of fluid in fluid reservoir 1916; and one or more of size and mobility of mist droplets that heater 1902 may produce. Controller 121 may ultimately determine one or more of the frequency and duration (e.g., the duty cycle) of activation of heater 1902, the amount of heat to be generated by heater 1902, and the off/on state of heater 1902 based on the determined amount of mist to be generated by mist generator 1900.

After one or more of S2014, S2016, S2018, and S2019 is completed, controller 121 may determine whether the holding process is complete in S2020. When controller 121 determines that the holding process is not complete (S2020: NO) (e.g., when there is no indication that the holding process is complete), the environmental control process returns to one or more of S2006, S2008, and S2010. In this manner, controller 121 may implement a feedback loop that controls the environmental conditions within holding cabinet 100 by periodically monitoring the humidity of air in holding cabinet 100, the temperature of air in holding cabinet 100, and the airflow rate in holding cabinet 100, which may help to maintain or reduce the degradation of the quality of the held product over an extended period of time.

In particular configurations and similar to the processes described with respect to FIG. 17, controller 121 may determine that the holding process is complete (S2020: YES) when the food product has been held for a certain period of time (e.g., a predetermined period of time corresponding to a length of time over which the quality of the food product would degrade significantly leading to poor taste or texture, a predetermined amount of time selected at the beginning of the holding process), at a certain time of day (e.g., at the close of business, at a transition time between breakfast and lunch, at a predetermined time selected at the beginning of the holding process), or when a particular event occurs (e.g., holding cabinet 100 is opened, water pan 716 runs out of water, a component of holding cabinet 100 or controller 121 malfunctions). When controller 121 determines that the holding process is complete (S1720: YES), controller 121 may end the holding process in S2022 and the environmental control process may end. When controller 121 ends the holding process in S2022, controller may, for example, deactivate one or more of air heater 706, air fan 708, and water pan heater 722.

In particular configurations, the memory may store a plurality of set point values, each of which may correspond to a predetermined range, within which at least one of the temperature, the humidity, and the airflow rate in the holding cabinet is to be maintained. In some configurations, each set point value, and each predetermined range corresponding to the set point, may be associated with a particular food product. In this manner, the environmental conditions for different food products, which may have different material properties, may be maintained in a manner that may be particularly suited for that product and that may extend the holding time before significant degradation of that product's quality occurs. For example, one set point may be associated with chicken nuggets, while another set point may be associated with churros (e.g., Spanish doughnuts). In this manner, the system may use an appropriate set point for a particular food product, which may further extend the holding time for that particular food product before significant degradation of quality occurs, after the system determines the type of the particular food product held or to be held in the holding cabinet.

In certain configurations, the memory may store a plurality of set point values which may be utilized at different times during the holding process. For example, one set point may be utilized for the first five minutes of holding, and another set point may be utilized for the remainder of the holding period. In still other configurations, different set points may be utilized upon the occurrence of different events. For example, one set point may be utilized when the food product is initially placed in the cabinet, and another set point may be utilized when a cabinet door is opened.

In particular configurations, the pattern of airflow within the holding cabinet may be changed as part of the environmental control process in response to the measured temperature, humidity, and airflow rates. Such changes may be in addition to or in lieu of changing the airflow rate. For example, introductory air vents may be selectively opened and closed to change the pattern of airflow. In certain configurations, air may be selectively introduced at different or varying angles in response to the measured temperature, humidity, and airflow rates, which may alter circulation patterns, humidity gradients, and temperature gradients throughout the holding cabinet. In some configurations, air may be selectively introduced in different directions (e.g., horizontal, vertical) and from different sides (e.g., top, bottom, right, left, back, front) of the holding cabinet, which also may alter circulation patterns, humidity gradients, and temperature gradients throughout the holding cabinet. In addition, similar patterns of humidity introduction (e.g., through steam jets) also may be utilized, alone or in combination, with such airflow patterns. For example, such changes in airflow and humidity introductions may be performed independently or in combination with S1714, S1716, and S1718 as part of the environmental control process.

In some configurations, the holding cabinet may comprise a plurality of zones (e.g., a multi-zone holding cabinet) for storing a plurality of different food products. For example, each zone of the plurality of zones may have its own set point value, and each of the temperature, the airflow rate, and the humidity may be regulated independently for in each zone. In some configurations, if one or more mist generators 1900 are utilized, one or more zones may include a dedicated mist generator 1900, for example. Such zones may be defined, for example, by one or more sub-cabinets within the holding cabinet, and each sub-cabinet may be separated by a wall (e.g., a solid wall, a porous wall). Further, each sub-cabinet may comprise its own temperature probe, humidity sensor, and airflow sensor, as well as its own heater, fan, and humidity generator, so that the environmental control process may be performed separately for each sub-cabinet. In other configurations, such zones may be defined, for example, by one or more virtual cabinets within the holding cabinet, which may each be a particular region within the holding cabinet (e.g., an upper region, a middle region, a lower region). Such virtual cabinets may not be physically separated from each other but may each comprise its own temperature probe, humidity sensor, and airflow sensor, as well as its own heater, fan, and humidity generator, so that the environmental control process may be performed separately for each virtual cabinet. In certain configurations, such virtual cabinets may not each comprise its own heater, fan, and humidity generator, and one or more of air, heat, and humidity may be introduced into each virtual cabinet by appropriately directing the one or more of air (e.g., air vents, which may be selectively opened and closed, angled in different directions to direct air to different zones within the holding cabinet), heat (e.g., creating zones requiring warmer temperatures near a heater at the top of the holding cabinet; disposing thermal masses in each zone to retain heat), and humidity (e.g., steam vents, which may be selectively opened and closed, angled in different directions to direct humidifying steam to different zones within the holding cabinet).

Although particular configurations disclosed above may utilize a free-standing holding cabinet, other holding cabinets may be utilized. For example, the systems and methods disclosed herein may be incorporated into a portable merchandiser (e.g., a pizza delivery container, another container for holding food to be delivered). Accordingly, such a portable merchandiser may be configured to perform the environmental control process and extend the holding period of to be delivered food products before the quality of such food products begins to degrade. Other types of holding containers also may be utilized.

While the invention has been described in connection with various exemplary structures and illustrative embodiments, it will be understood by those skilled in the art that other variations and modifications of the structures, configurations, and embodiments described above may be made without departing from the scope of the invention. For example, this application includes all possible combinations of the various elements and features disclosed and incorporated by reference herein, and the particular elements and features presented in the claims and disclosed and incorporated by reference above may be combined with each other in other ways within the scope of the application, such that the application should be recognized as also directed to other embodiments including other possible combinations. Other structures, configurations, and embodiments consistent with the scope of the claimed invention will be apparent to those skilled in the art from a consideration of the specification or practice of the invention disclosed herein. It is intended that the specification and the described examples are illustrative with the true scope of the invention being defined by the following claims.

What is claimed is:

1. A method for maintaining environmental conditions in a cabinet, comprising:
determining a relative humidity set point;
activating a fan configured to circulate air within said cabinet;
activating a humidity-generating device;
measuring a relative humidity, an air temperature, and a rate of airflow in said cabinet; and
adjusting a duty cycle of said humidity-generating device and said fan in response to said air temperature, said relative humidity, and said rate of airflow to maintain said relative humidity within a predetermined range based on the relative humidity set point.

2. The method according to claim 1, wherein the relative humidity set point is determined based on a particular type of product to be placed in said cabinet.

3. The method according to claim 1, wherein the humidity-generating device includes a heater in a fluid pan.

4. The method according to claim 1, wherein the humidity-generating device includes a mist generator, the mist generator including:
a fluid reservoir;
a wicking device configured to wick fluid from the fluid reservoir toward the heater; and
a heater configured to generate mist by evaporating fluid wicked by the wicking device.

5. The method according to claim 4,
wherein the mist generator further includes an electrode, and
wherein the method further comprises:
determining whether the fluid in the fluid reservoir is within a predetermined range based on a signal provided by the electrode; and
performing at least one of the following in response to determining that the fluid in the fluid reservoir is not within the predetermined range:
adding additional fluid to the fluid reservoir; and
removing fluid from the fluid reservoir.

6. The method according to claim 1,
wherein said cabinet includes a plurality of zones, and
wherein the method further comprises, for each zone of the plurality of zones:
determining a respective relative humidity set point for the respective zone;
activating a respective fan configured to circulate air within the respective zone;
activating a respective humidity-generating device within the respective zone;
measuring a relative humidity, an air temperature, and a rate of airflow within the respective zone; and
adjusting a duty cycle of said respective humidity-generating device and said respective fan in response to said air temperature, said relative humidity, and said rate of airflow within the respective zone to maintain said relative humidity in the respective zone within a predetermined range based on the relative humidity set point for the respective zone.

7. The method according to claim 4, wherein an average diameter of the heater is less than an average diameter of the wick device, such that the mist is released from the mist generator at a perimeter of the heater.

8. A system configured to maintain environmental conditions in a cabinet, comprising:
a processor; and
a memory storing computer-readable instructions that, when executed by the processor, instruct the processor to perform processes comprising:
determining a relative humidity set point;
activating a fan configured to circulate air within said cabinet;
activating a humidity-generating device;
measuring a relative humidity, an air temperature, and a rate of airflow in said cabinet; and
adjusting a duty cycle of said humidity-generating device and said fan in response to said air temperature, said relative humidity, and said rate of airflow to maintain said relative humidity within a predetermined range based on the relative humidity set point.

9. The system according to claim 8, wherein the computer-readable instructions instruct the processor to determine the relative humidity set point based on a particular type of product to be placed in said cabinet.

10. The system according to claim 8, wherein the humidity-generating device includes a heater in a fluid pan.

11. The system according to claim 8, wherein the humidity-generating device includes a mist generator, the mist generator including:
a fluid reservoir;
a wicking device configured to wick fluid from the fluid reservoir toward the heater; and
a heater configured to generate mist by evaporating fluid wicked by the wicking device.

12. The system according to claim 11,
wherein the mist generator further includes an electrode,
wherein the computer-readable instructions instruct the processor to determine whether the fluid in the fluid reservoir is within a predetermined range based on a signal provided by the electrode,
wherein the computer-readable instructions instruct the processor to perform at least one of the following in response to determining that the fluid in the fluid reservoir is not within the predetermined range:
controlling a pump to add additional fluid to the fluid reservoir; and
controlling mist generator to discharge fluid from the fluid reservoir.

13. The system according to claim 8,
wherein said cabinet includes a plurality of zones, and
wherein the computer-readable instructions instruct the processor to perform processes further comprising, for each zone of the plurality of zones:
determining a respective relative humidity set point for the respective zone;
activating a respective fan configured to circulate air within the respective zone;
activating a respective humidity-generating device within the respective zone;
measuring a relative humidity, an air temperature, and a rate of airflow within the respective zone; and
adjusting a duty cycle of said respective humidity-generating device and said respective fan in response to said air temperature, said relative humidity, and said rate of airflow within the respective zone to maintain said relative humidity in the respective zone within a predetermined range based on the relative humidity set point for the respective zone.

14. The system according to claim 11, wherein an average diameter of the heater is less than an average diameter of the wick device, such that the mist generator is configured to release the mist at a perimeter of the heater.

15. The system according to claim 11,
wherein the wicking device includes a wicking material extending in a longitudinal direction between a base portion of the mist generator and the heater, and
wherein the wicking material is configured to convey fluid, via capillary action, in the longitudinal direction from the fluid reservoir to the heater.

16. The system according to claim 15, wherein the wicking material is a porous material.

17. The system according to claim 15, wherein the wicking material is cotton.

18. The system according to claim 15, wherein the wicking material includes a plurality of rope-like strands extending in the longitudinal direction.

19. The system according to claim 15, wherein the wicking material is a ceramic.

20. A non-transitory, computer-readable medium storing computer-readable instructions that, when executed by a processor, instruct the processor to perform processes comprising:
determining a relative humidity set point;
activating a fan configured to circulate air within a cabinet;
activating a humidity-generating device;
measuring a relative humidity, an air temperature, and a rate of airflow in said cabinet; and
adjusting a duty cycle of said humidity-generating device and said fan in response to said air temperature, said relative humidity, and said rate of airflow to maintain said relative humidity within a predetermined range based on the relative humidity set point.

21. The non-transitory, computer-readable medium according to claim 20, wherein the computer-readable instructions instruct the processor to determine the relative humidity set point based on a particular type of product to be placed in said cabinet.

22. The non-transitory, computer-readable medium according to claim 20, wherein the humidity-generating device includes a heater in a fluid pan.

23. The non-transitory, computer-readable medium according to claim 20, wherein the humidity-generating device includes a mist generator, the mist generator including:
a fluid reservoir;
a wicking device configured to wick fluid from the fluid reservoir toward the heater; and
a heater configured to generate mist by evaporating fluid wicked by the wicking device.

24. The non-transitory, computer-readable medium according to claim 23,
wherein the mist generator further includes an electrode,
wherein the computer-readable instructions instruct the processor to determine whether the fluid in the fluid reservoir is within a predetermined range based on a signal provided by the electrode,
wherein the computer-readable instructions instruct the processor to perform at least one of the following in response to determining that the fluid in the fluid reservoir is not within the predetermined range:
controlling a pump to add additional fluid to the fluid reservoir; and
controlling mist generator to discharge fluid from the fluid reservoir.

25. The non-transitory, computer-readable medium according to claim 20,
wherein said cabinet includes a plurality of zones, and
wherein the computer-readable instructions instruct the processor to perform processes further comprising, for each zone of the plurality of zones:
determining a respective relative humidity set point for the respective zone;
activating a respective fan configured to circulate air within the respective zone;
activating a respective humidity-generating device within the respective zone;
measuring a relative humidity, an air temperature, and a rate of airflow within the respective zone; and
adjusting a duty cycle of said respective humidity-generating device and said respective fan in response to said air temperature, said relative humidity, and said rate of airflow within the respective zone to maintain said relative humidity in the respective zone within a predetermined range based on the relative humidity set point for the respective zone.

26. The non-transitory, computer-readable medium according to claim 23, wherein an average diameter of the heater is less than an average diameter of the wick device, such that the mist is released from the mist generator at a perimeter of the heater.
